(19) United States
(12) Patent Application Publication
(10) Pub. No.: US 2021/0229328 A1
(43) Pub. Date: Jul. 29, 2021

(54) OVER-MOLDED THERMOPLASTIC COMPOSITE PART HAVING OVER-MOLDED COLOR AND METHOD OF FABRICATING THE SAME

(71) Applicant: The Boeing Company, Chicago, IL (US)

(72) Inventors: Christopher H. Childers, Saint Charles, MO (US); Cori A. Jackson Oliver, Saint Charles, MO (US); Gregg R. Bogucki, Saint Charles, MO (US)

(73) Assignee: The Boeing Company

(21) Appl. No.: 16/776,474

(22) Filed: Jan. 29, 2020

(51) Int. Cl. B29C 45/14; B64C 1/12; B64D 11/00

(52) U.S. Cl. CPC B29C 45/14631; B29K 2105/0032; B64D 11/00; B64C 1/12

(57) ABSTRACT

There is provided an over-molded thermoplastic composite part having an over-molded color, and including a consolidated thermoplastic composite laminate formed by a consolidation process. The consolidated thermoplastic composite laminate is made of a laminate polymer material. The over-molded thermoplastic composite part further includes an over-mold layer over-molded, via an over-molding process, over a first side of the consolidated thermoplastic composite laminate. The over-mold layer includes an over-mold mixture of an over-mold polymer material mixed with one or more additives, including at least a color additive to impart a color to the consolidated thermoplastic composite laminate during the over-molding process. The over-mold polymer material has a melting temperature that is greater than, or equal to, a melting temperature of the laminate polymer material, and that is less than a thermal degradation temperature of the laminate polymer material. The over-molding process results in the over-molded thermoplastic composite part having the over-molded color.

### FIELD

The disclosure relates generally to thermoplastic composite laminates and parts and methods of fabricating the same, and more particularly, to over-molded thermoplastic composite laminates and parts having over-molded color and methods of fabricating the same, for use in and on vehicles.

### BACKGROUND

Thermoplastic composite laminates and parts are used in a wide variety of applications, including for interior and exterior panels and structures, in and on vehicles, such as aerospace vehicles (e.g., aircraft, spacecraft, rotorcraft, etc.), automobiles, and watercraft. Thermoplastic composite laminates may be over-molded with an over-molding process to either join multiple thermoplastic composite laminates together, or to fabricate over-mold structures, for example, brackets, clips, and the like, made of discontinuous reinforced thermoplastic materials, over a formed thermoplastic composite laminate. An over-molding process, also referred to as a hybrid molding process, is a process for forming a single part using two or more separate or different elements in combination, where the first element, such as a substrate or base laminate, is formed first, and then is partially or fully covered, by one or more over-mold elements or structures during the manufacturing process.

Known over-molding processes to join thermoplastic composite laminates together exist. However, the joined thermoplastic composite laminates formed from such known over-molding processes are typically not in a final net shape and typically need to undergo multiple finishing operations, or secondary operations, such as surface preparation operations (e.g., sanding, grit blasting, etc.), painting operations, trimming operations, or other types of finishing operations, or secondary operations, prior to assembly with other structures, or prior to installation in a vehicle. For example, painting operations may be performed after the joined thermoplastic composite laminates are formed and the surface has been prepared in some manner. Such multiple finishing operations, or secondary operations, may be time consuming and labor intensive and may increase the overall cost of manufacturing.

Moreover, to impart properties, such as color, ultraviolet (UV) light protection and stabilization, thermal conductivity, and/or electrical conductivity to the joined thermoplastic composite laminates, additional layers need to be added to the joined thermoplastic composite laminates after formation, to impart one or more of such properties to the formed base laminate or laminates. Adding such additional layers may be time consuming and labor intensive and may increase the overall cost of manufacturing.

In addition, known over-molding processes to fabricate over-mold structures, for example, brackets, clips, and the like, exist. However, because such formed over-mold structures are typically not visible to passengers or users, they are not typically decoratively painted, do not have color, and do not impart color to the over-molded laminate or laminates.

It is desirable to be able to over-mold visible color on formed thermoplastic composite laminates, via an over-molding process, in a rapid and inexpensive manner. It is further desirable to be able to impart such properties as ultraviolet (UV) light protection, thermal conductivity, and/or electrical conductivity, on formed thermoplastic composite laminates, via an over-molding process, in a rapid and inexpensive manner. It is further desirable to fabricate over-molded thermoplastic composite parts, via an over-molding process, that have a final net shape and require no finishing operations or secondary operations, such as surface preparation operations, painting operations, trimming operations, or other types of finishing operations or secondary operations, prior to assembly with other structures, or prior to installation in a vehicle.

Accordingly, there is a need in the art for over-molded thermoplastic composite parts and methods of forming the same that impart color and other properties to formed thermoplastic composite laminates, that eliminate the need for finishing operations, or secondary operations, prior to assembly or installation, that decrease the time, labor, and cost of manufacturing, and that provide advantages over known over-molding products, systems, and methods.

### SUMMARY

Example implementations of the present disclosure provide for over-molded thermoplastic composite parts having over-molded color, and methods of forming the same using an over-molding process. As discussed in the below detailed description, versions of the over-molded thermoplastic composite parts having over-molded color, and methods of forming the same using an over-molding process may provide significant advantages over known over-molding products, systems, and methods.

In a version of the disclosure, there is provided an over-molded thermoplastic composite part having an over-molded color. The over-molded thermoplastic composite part comprises a consolidated thermoplastic composite laminate formed by a consolidation process. The consolidated thermoplastic composite laminate has a first side and a second side and is comprised of a laminate polymer material.

The over-molded thermoplastic composite part further comprises an over-mold layer over-molded, via an over-molding process, over the first side of the consolidated thermoplastic composite laminate. The over-mold layer comprises an over-mold mixture comprised of an over-mold polymer material mixed with one or more additives. The one or more additives comprise at least a color additive to impart a color to the consolidated thermoplastic composite laminate during the over-molding process. The over-mold polymer material has a melting temperature that is greater than, or equal to, a melting temperature of the laminate polymer material, and the melting temperature of the over-mold polymer material is less than a thermal degradation temperature of the laminate polymer material. The over-molding process results in the over-molded thermoplastic composite part having the over-molded color, having a final net shape, and requiring no finishing operations.

In another version of the disclosure, there is provided a vehicle. The vehicle comprises an exterior and an interior. The vehicle further comprises one or more over-molded thermoplastic composite parts. Each of the one or more over-molded thermoplastic composite parts has an over-molded color, and each is installed on one or more of, exterior portions of the exterior of the vehicle, and interior portions of the interior of the vehicle.

Each of the one or more over-molded thermoplastic composite parts comprises a consolidated thermoplastic composite laminate formed by a consolidation process. The consolidated thermoplastic composite laminate has a first side and a second side and is comprised of a laminate polymer material.

Each of the one or more over-molded thermoplastic composite parts further comprises an over-mold layer over-molded, via an injection molding process, over the first side of the consolidated thermoplastic composite laminate. The over-mold layer comprises an over-mold mixture comprised of an over-mold polymer material mixed with one or more additives. The one or more additives comprise at least a color additive to impart a color to the consolidated thermoplastic composite laminate during the injection molding process. The over-mold polymer material has a melting temperature that is greater than, or equal to, a melting temperature of the laminate polymer material, and the melting temperature of the over-mold polymer material is less than a thermal degradation temperature of the laminate polymer material.

The injection molding process results in each of the one or more over-molded thermoplastic composite parts having the over-molded color, having a final net shape, and requiring no finishing operations.

In another version of the disclosure, there is provided a method of fabricating an over-molded thermoplastic composite part having an over-molded color. The method comprises the step of forming a consolidated thermoplastic composite laminate using a consolidation process. The consolidated thermoplastic composite laminate has a first side and a second side and is comprised of a laminate polymer material.

The method further comprises the step of over-molding an over-mold layer over the first side of the consolidated thermoplastic composite laminate, using an over-molding process. The over-mold layer comprises an over-mold mixture comprised of an over-mold polymer material mixed with one or more additives. The one or more additives comprise at least a color additive to impart color to the consolidated thermoplastic composite laminate during the over-molding process. The over-mold polymer material has a melting temperature that is greater than, or equal to, a melting temperature of the laminate polymer material, and the melting temperature of the over-mold polymer material is less than a thermal degradation temperature of the laminate polymer material.

The method further comprises the step of obtaining the over-molded thermoplastic composite part having the over-molded color, having a final net shape, and requiring no finishing operations.

The features, functions, and advantages that have been discussed can be achieved independently in various embodiments of the disclosure or may be combined in yet other embodiments further details of which can be seen with reference to the following description and drawings.

### BRIEF DESCRIPTION OF THE DRAWINGS

The disclosure can be better understood with reference to the following detailed description taken in conjunction with the accompanying drawings which illustrate preferred and exemplary versions, but which are not necessarily drawn to scale, wherein:

FIG. 1A is an illustration of a functional block diagram showing exemplary versions of an over-molded thermoplastic composite part of the disclosure;

FIG. 1B is an illustration of a functional block diagram showing an exemplary version of a vehicle incorporating one or more over-molded thermoplastic composite parts of the disclosure;

FIG. 2A is an illustration of a side view of a version of an over-molded thermoplastic composite part of the disclosure;

FIG. 2B is an illustration of a side view of another version of an over-molded thermoplastic composite part of the disclosure;

FIG. 2C is an illustration of a bottom perspective view of the over-molded thermoplastic composite part of FIG. 2B;

FIG. 2D is an illustration of a side view of yet another version of an over-molded thermoplastic composite part of the disclosure;

FIG. 3A is an illustration of a flow diagram of a version of a method of the disclosure;

FIG. 3B is an illustration of a flow diagram of another version of a method of the disclosure;

FIG. 4A is an illustration of a bottom view of an exemplary version of a consolidated thermoplastic composite laminate of the disclosure installed on a first injection molding tool of a mold assembly;

FIG. 4B is an illustration of a side view of the consolidated thermoplastic composite laminate of FIG. 4A installed on the mold assembly, and showing a first injection nozzle attached to a second injection molding tool;

FIG. 4C is an illustration of a side view of the consolidated thermoplastic composite laminate and the mold assembly of FIG. 4B, and showing the first injection nozzle dispensing a structural over-mold mixture to structural over-mold a structural over-mold layer over a second side of the consolidated thermoplastic composite laminate;

FIG. 4D is an illustration of a side view of the consolidated thermoplastic composite laminate, the mold assembly, and structural over-mold layer of FIG. 4C, and showing a second injection nozzle dispensing an over-mold mixture to over-mold an over-mold layer having an over-molded color over a first side of the consolidated thermoplastic composite laminate;

FIG. 4E is an illustration of a side view of a version of an over-molded thermoplastic composite part having an over-molded color and having a structural over-mold layer;

FIG. 5 is an illustration of a perspective view of an aircraft that includes an over-molded thermoplastic composite part of the disclosure;

FIG. 6 is an illustration of a flow diagram of an exemplary aircraft manufacturing and service method; and

FIG. 7 is an illustration of an exemplary block diagram of an aircraft.

The figures shown in this disclosure represent various aspects of the versions presented, and only differences will be discussed in detail.

### DETAILED DESCRIPTION

Disclosed versions or embodiments will now be described more fully hereinafter with reference to the accompanying drawings, in which some, but not all of the disclosed versions are shown. Indeed, several different versions may be provided and should not be construed as limited to the versions set forth herein. Rather, these versions are provided so that this disclosure will be thorough and fully convey the scope of the disclosure to those skilled in the art.

This specification includes references to “one version” or “a version”. The instances of the phrases “in one version” or “in a version” do not necessarily refer to the same version. Particular features, structures, or characteristics may be combined in any suitable manner consistent with this disclosure.

As used herein, “comprising” is an open-ended term, and as used in the claims, this term does not foreclose additional structure or steps.

As used herein, “configured to” means various parts or components may be described or claimed as “configured to” perform a task or tasks. In such contexts, “configured to” is used to connote structure by indicating that the parts or components include structure that performs those task or tasks during operation. As such, the parts or components can be said to be configured to perform the task even when the specified part or component is not currently operational (e.g., is not on).

As used herein, the terms “first”, “second”, etc., are used as labels for nouns that they precede, and do not imply any type of ordering (e.g., spatial, temporal, logical, etc.).

As used in the claims and herein, the term “or” is used as an inclusive or and not as an exclusive or. For example, the phrase “at least one of x, y, or z” and “one of x, y, or z” mean any one of x, y, and z, as well as any combination thereof.

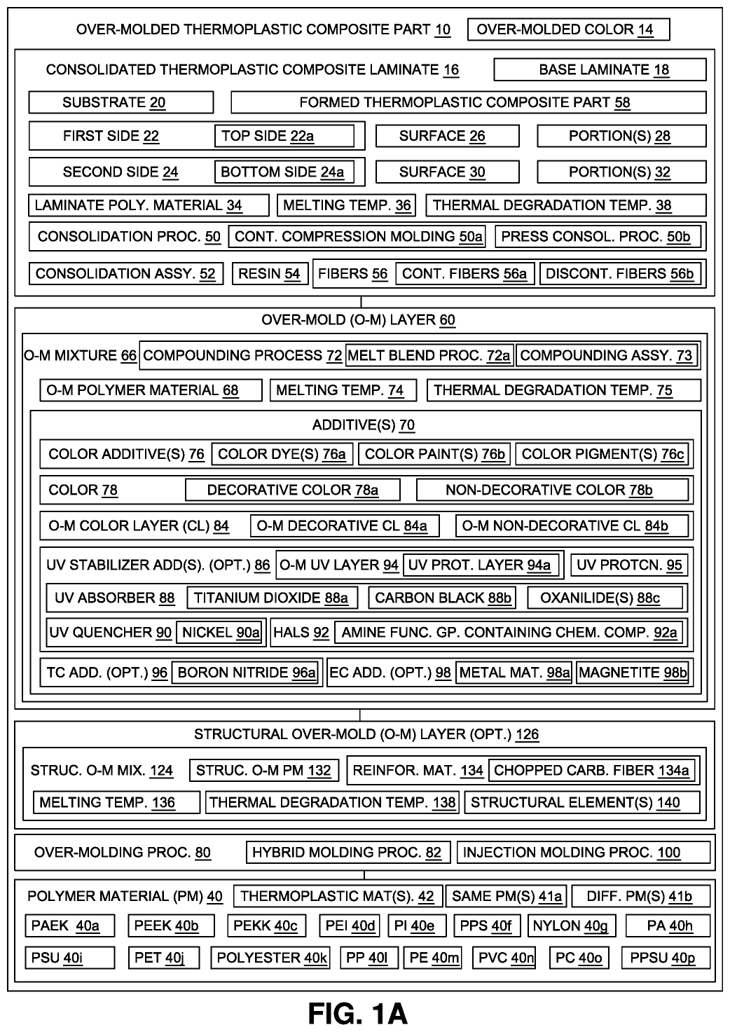

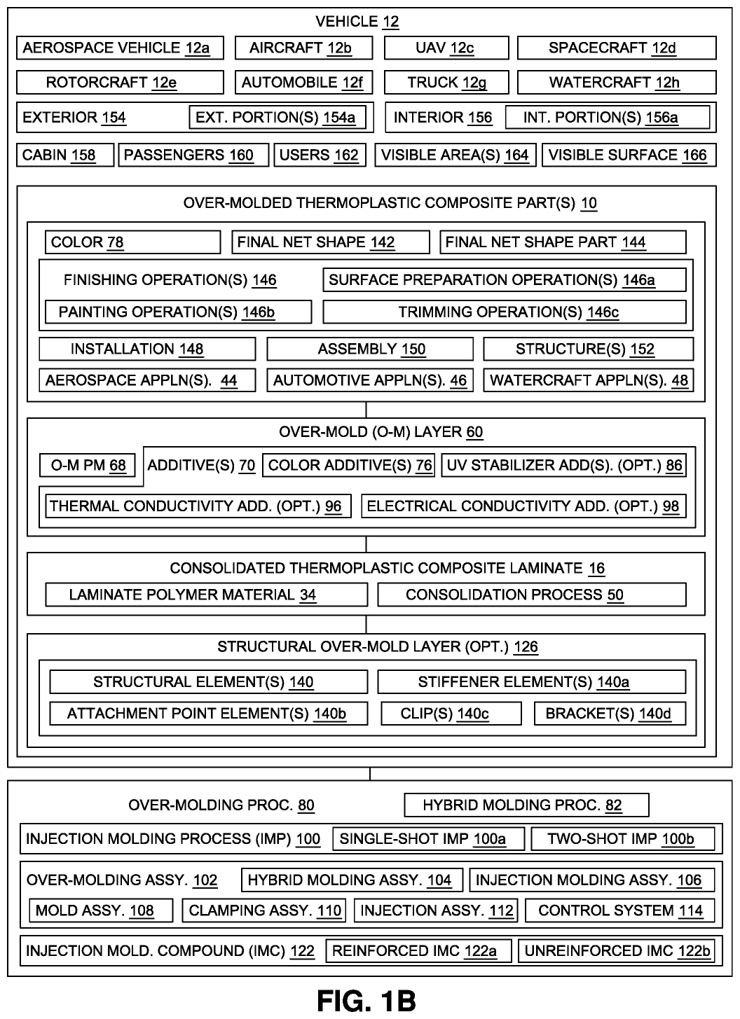

Now referring to the Figures, FIG. 1A is an illustration of a functional block diagram showing exemplary versions of an over-molded thermoplastic composite part 10 of the disclosure, and FIG. 1B is an illustration of a functional block diagram showing an exemplary version of a vehicle 12 incorporating one or more over-molded thermoplastic composite parts 10 of the disclosure. As shown in FIG. 1B, the vehicle 12 may comprise an aerospace vehicle 12a, an aircraft 12b, an unmanned aerial vehicle (UAV) 12c such as a drone, a spacecraft 12d, a rotorcraft 12e, an automobile 12f, a truck 12g, a watercraft 12h, or another suitable vehicle.

The blocks in FIGS. 1A and 1B represent elements, and lines connecting the various blocks do not imply any particular dependency of the elements. Furthermore, the connecting lines shown in the various Figures contained herein are intended to represent example functional relationships and/or physical couplings between the various elements, but it is noted that other alternative or additional functional relationships or physical connections may be present in versions disclosed herein.

In one version, as shown in FIG. 1A and disclosed herein, there is provided an over-molded thermoplastic composite part 10 having an over-molded color 14. As shown in FIGS. 1A-1B, the over-molded thermoplastic composite part 10 comprises a consolidated thermoplastic composite laminate 16. The consolidated thermoplastic composite laminate 16 may also be referred to as a base laminate 18 (see FIG. 1A), or a substrate 20 (see FIG. 1A).

As shown in FIG. 1A, the consolidated thermoplastic composite laminate 16 comprises a first side 22, such as a top side 22a, and comprise a second side 24, such as a bottom side 24a. As further shown in FIG. 1A, the first side 22 has a surface 26 comprised of one or more portions 28, and the second side 24 has a surface 30 comprised of one or more portions 32.

The consolidated thermoplastic composite laminate 16 is comprised of, or made of, a laminate polymer material 34 (see FIGS. 1A-1B), also referred to as a base laminate polymer material. As shown in FIG. 1A, the laminate polymer (poly.) material 34 has a melting temperature (temp.) 36 and a thermal degradation temperature (temp.) 38.

The laminate polymer material 34 is comprised of one or more polymer materials (PMs) 40 (see FIG. 1A), such as one or more thermoplastic materials 42 (see FIG. 1A). As shown in FIG. 1A, the polymer material 40, such as the thermoplastic material 42, preferably comprises one or more of polyaryletherketones (PAEKs) 40a, such as polyether ether ketone (PEEK) 40b and polyether ketone (PEKK) 40c, polyetherimide (PEI) 40d, polyimide (PI) 40e, polyphenylene sulfide (PPS) 40f, nylon 40g, polyamide (PA) 40h, polysulfone (PSU) 40i, polyethylene terephthalate (PET) 40j, polyester 40k, polypropylene (PP) 40l, polyethylene (PE) 40m, polyvinyl chloride (PVC) 40n, polycarbonate (PC) 40o, polyphenylsulfone (PPSU) 40p, or another suitable polymer material.

The laminate polymer materials 34 particularly suited for aerospace applications 44 (see FIG. 1B) for vehicles 12, such as aerospace vehicles 12a, aircraft 12b, unmanned aerial vehicle (UAV) 12c such as a drone, spacecraft 12d, rotorcraft 12e, and other aerospace vehicles, include polyaryletherketone (PAEK) 40a, such as polyether ether ketone (PEEK) 40b and polyether ketone ketone (PEKK) 40c, polyetherimide (PEI) 40d, polyimide (PI) 40e, and polyphenylene sulfide (PPS) 40f. The laminate polymer materials 34 particularly suited for automotive applications 46 (see FIG. 1B) for vehicles 12, such as automobiles 12f, trucks 12g, and other automotive vehicles, include polyamide (PA) 40h and polysulfone (PSU) 40i. The laminate polymer materials 34 particularly suited for watercraft applications 48 (see FIG. 1B) for vehicles 12, such as watercraft 12h, include PEEK 40b, PEKK 40c, PEI 40d, and PPS 40f. Watercraft applications 48 may also include use for marine components and structures, including both sub-scale and full-scale components, e.g., parts or full structures, depending on the size of the watercraft 12h.

As further shown in FIGS. 1A-1B, the consolidated thermoplastic composite laminate 16 is preferably formed by a consolidation process 50. The consolidation process 50 is performed with a consolidation assembly 52 (see FIG. 1A). As shown in FIG. 1A, the consolidation process 50 may comprise a continuous (cont.) compression molding 50a, a press consolidation (consol.) process (proc.) 50b, or another suitable consolidation process. As used herein, the term “consolidation” means the application of heat and pressure to melt and join individual plies reinforced with thermoplastic material into a single, solid laminate, and cooling of the laminate to solidify and harden the laminate. Heat may be applied with heating methods, such as induction, microwave, ultrasonic, resistance, hot jet, laser, autoclave, plasma, or another suitable heating method. Pressure may be applied with pressurizing techniques or structures, such as molding or tooling, vacuum bagging, compression, rollers, or another suitable pressurizing technique or structure.

During the consolidation process 50, the heat and/or pressure results in flow of resin 54 (see FIG. 1A) and wetting of fibers 56 (see FIG. 1A) of the polymer material 40, such as the thermoplastic material 42. The fibers 56 may comprise continuous (cont.) fibers 56a (see FIG. 1A), or discontinuous (discont.) fibers 56b (see FIG. 1A). Continuous fibers 56a, such as continuous carbon fibers, are oriented in a parallel, in-plane fiber orientation and have long aspect ratios (i.e., ratio of length of fiber to diameter of fiber), for example, unidirectional fibers, woven cloth, and helical windings. Continuous fiber composites may be laminated materials in which the individual layers, plies, or sheets of continuous fibers are oriented in directions that enhance the strength and stiffness in the primary load direction. Discontinuous fibers 56b, such as discontinuous carbon fibers, are oriented in a random, in-plane fiber orientation and have short aspect ratios, for example, chopped fibers and random mats. Discontinuous fiber composites may be laminated materials in which the individual layers, plies, or sheets of discontinuous fibers are oriented randomly in alignment.

The consolidation process 50 results in the consolidated thermoplastic composite laminate 16. The consolidated thermoplastic composite laminate 16 may be in the form of a formed thermoplastic composite part 58 (see FIG. 1A).

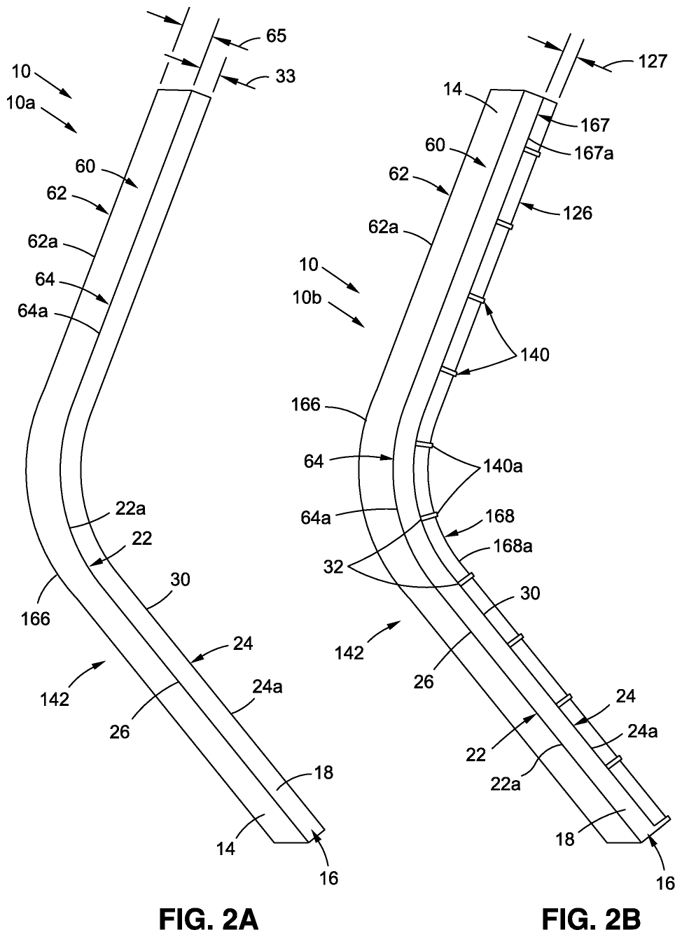

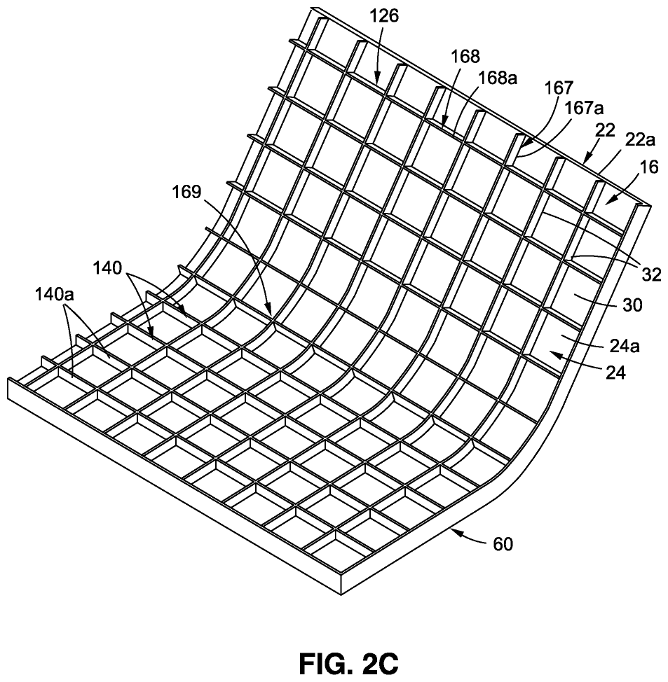

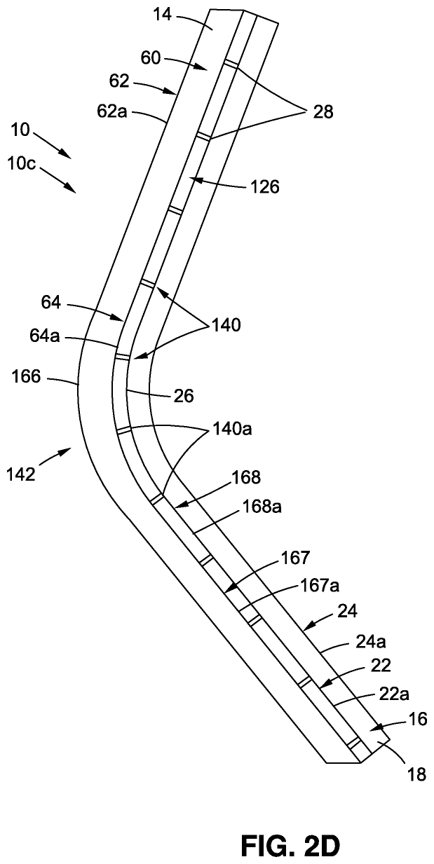

As shown in FIGS. 1A-1B, the over-molded thermoplastic composite part 10 further comprises an over-mold (O-M) layer 60. In exemplary versions shown in FIGS. 2A, 2B, and 2D, and discussed in further detail below, the over-mold layer 60 has a first side 62, such as a top side 62a, and has a second side 64, such as a bottom side 64a.

As shown in FIG. 1A, the over-mold layer 60 is comprised of, or made of, an over-mold (O-M) mixture 66. The over-mold mixture 66 is comprised of, or made of, an over-mold (O-M) polymer material 68 (see FIGS. 1A-1B), or over-mold polymer materials 68, mixed with one or more additives 70 (see FIGS. 1A-1B). The over-mold mixture 66 is preferably made with a compounding process 72 (see FIG. 1A), such as a melt blending process 72a (see FIG. 1A) using a compounding assembly 73 (see FIG. 1A). As used herein, “compounding” means melt blending one or more polymer materials, such as one or more over-mold polymer materials, with one or more additives, or other compounds, where the compounding process changes the physical, thermal, electrical, or aesthetic characteristics of the one or more polymer materials.

Each of the one or more over-mold polymer materials 68 has a melting temperature 74 (see FIG. 1A) and a thermal degradation temperature 75 (see FIG. 1A). It is critical, or a requirement, to fabricate the over-molded thermoplastic composite part 10, so that the over-mold polymer material 68, for example, each of the one or more over-mold polymer materials 68, has a melting temperature 74 that is greater than, or equal to, the melting temperature 36 of the laminate polymer material 34, for example, each of the one or more laminate polymer materials 34, and so that the melting temperature 74 of the over-mold polymer material 68, for example, each of the one or more over-mold polymer materials 68, is less than a thermal degradation temperature 38 of the laminate polymer material 34, for example, each of the one or more laminate polymer materials 34.

As used herein, “melting temperature” means the temperature at which a polymer material, such as the over-mold polymer material 68, and the laminate polymer material 34 discussed above, and a structural over-mold (O-M) polymer material (PM) 132, discussed below, changes state from a solid to a liquid. As used herein, “thermal degradation temperature” means the temperature at which a polymer material, such as the over-mold polymer material 68, and the laminate polymer material 34 discussed above, and the structural over-mold polymer material 132, discussed below, undergoes molecular deterioration due to overheating, and the thermal degradation temperature represents an upper limit to a service temperature of the polymer material. For example, at high temperatures, components of a long chain backbone of the polymer material may begin to break and react with one another to change the properties of the polymer material.

The over-mold polymer material 68 is comprised of one or more polymer materials 40 (see FIG. 1A), such as one or more thermoplastic materials 42 (see FIG. 1A). As shown in FIG. 1A, the polymer material 40, such as the thermoplastic material 42, preferably comprises one or more of, polyaryletherketones (PAEKs) 40a, such as polyether ether ketone (PEEK) 40b and polyether ketone ketone (PEKK) 40c, polyetherimide (PEI) 40d, polyimide (PI) 40e, polyphenylene sulfide (PPS) 40f, nylon 40g, polyamide (PA) 40h, polysulfone (PSU) 40i, polyethylene terephthalate (PET) 40j, polyester 40k, polypropylene (PP) 40l, polyethylene (PE) 40m, polyvinyl chloride (PVC) 40n, polycarbonate (PC) 40o, polyphenylsulfone (PPSU) 40p, or another suitable polymer material.

In one version of fabricating the over-molded thermoplastic composite part 10 with the over-molded color 14, the one or more polymer materials 40 used to form the laminate polymer material 34 may be the same polymer material(s) 41a (see FIG. 1A) as the one or more polymer materials 40 used to form the over-mold polymer materials 68. In another version of fabricating the over-molded thermoplastic composite part 10 with the over-molded color 14, the one or more polymer materials 40 used to form the laminate polymer material 34 may be one or more different polymer material(s) 41b (see FIG. 1A) as the one or more polymer materials 40 used to form the over-mold polymer materials 68.

As shown in FIGS. 1A-1B, the one or more additives 70 of the over-mold mixture 66 (see FIG. 1A) comprise at least a color additive 76, and preferably, one or more color additives 76, to impart color 78 to the consolidated thermoplastic composite laminate 16 and to the over-molded thermoplastic composite part 10, during an over-molding process (proc.) 80, also referred to as a hybrid molding process (proc.) 82. As further shown in FIG. 1A, the one or more color additives 76 preferably comprise one or more of, one or more color dyes 76a, one or more color paints 76b, one or more color pigments 76c, or other suitable color additives. The color 78 in the over-mold layer 60 may function as a decorative color 78a (see FIG. 1A), or a non-decorative color 78b (see FIG. 1A). As shown in FIG. 1A, with the color 78 in the over-mold layer 60, the over-mold layer 60 may function as an over-mold (O-M) color layer (CL) 84, such as in the form of an over-mold decorative color layer 84a, or such as in the form of an over-mold non-decorative color layer 84b, for example, an over-mold non-decorative color layer 84b comprising a color paint 76b to prevent corrosion, or to achieve electrical isolation if the over-molded thermoplastic composite part 10 will be in contact with a metal component, such as an aluminum component.

As further shown in FIGS. 1A-1B, the one or more additives 70 of the over-mold mixture 66 (see FIG. 1A) may further optionally comprise one or more ultraviolet (UV) (light) stabilizer additives 86. The one or more UV stabilizer additives 86 may comprise one or more of, one or more ultraviolet (UV) absorbers 88, one or more ultraviolet (UV) quenchers 90, one or more hindered amine light stabilizer (HALS) 92, or other suitable UV stabilizer additives. As used here, “ultraviolet (UV)” means electromagnetic radiation having a wavelength range of from 10 nm (ten nanometers) to 400 nm (four hundred nanometers).

The UV absorbers 88 are a type of light stabilizer that functions by competing with chromophores to absorb UV (ultraviolet) radiation, and the UV absorbers change UV radiation into infrared (IR) radiation, or heat, that is dissipated through a polymer matrix. The one or more UV absorbers 88 may comprise titanium dioxide (TiO₂) 88a (see FIG. 1A), for example, rutile titanium dioxide, which is effective in the 300 nm (three hundred nanometer) to 400 nm (four hundred nanometer) range, carbon black 88b (see FIG. 1A), one or more oxanilides 88c (see FIG. 1A), or other suitable UV absorbers.

The UV quenchers 90 quench an excited state of a carbonyl group formed during photo-oxidation of a polymer material and through decomposition of hydroperoxides, and this prevents bond cleavage and the formation of free radicals. The one or more UV quenchers 90 may comprise nickel 90a (see FIG. 1A), or other suitable UV quenchers.

The HALS 92 are long-term thermal stabilizers that act by trapping free radicals formed during photo-oxidation of a polymer material and limiting the photodegradation process. The one or more HALS 92 may comprise an amine functional group containing chemical compound (amine func. gp. containing chem. comp.) 92a (see FIG. 1A), or other suitable HALS.

As shown in FIG. 1A, with the ultraviolet (UV) stabilizer additive 86 in the over-mold layer 60, the over-mold layer 60 may additionally function as an over-mold (O-M) ultraviolet (UV) layer 94, such as in the form of an ultraviolet (UV) protective (prot.) layer 94a. The UV (light) protective layer 94a imparts ultraviolet (UV) (light) protection (protcn.) 95 (see FIG. 1A) to the consolidated thermoplastic composite laminate 16.

As further shown in FIGS. 1A-1B, the one or more additives 70 of the over-mold mixture 66 (see FIG. 1A) may further optionally comprise a thermal conductivity additive (TC ADD.) 96, such as boron nitride 96a (see FIG. 1A), or another suitable thermal conductivity additive, to impart thermal conductivity to the consolidated thermoplastic composite laminate 16. As further shown in FIGS. 1A-1B, the one or more additives 70 of the over-mold mixture 66 (see FIG. 1A) may further optionally comprise an electrical conductivity additive (EC ADD.) 98, such as a metal material 98a (see FIG. 1A), for example, magnetite 98b (see FIG. 1A), or another suitable electrical conductivity additive, to impart electrical conductivity to the consolidated thermoplastic composite laminate 16.

The over-mold layer 60 with the one or more additives 70 is over-molded, via the over-molding process 80, or the hybrid molding process 82, over one or more portions 28 (see FIG. 1A) of the first side 22 (see FIG. 1A) of the consolidated thermoplastic composite laminate 16. The over-mold layer 60 may be molded over and/or around the consolidated thermoplastic composite laminate 16. As used herein, “over-molding” or “hybrid molding” means a process where a single part is created using two or more separate elements in combination, where the first element, for example, the consolidated thermoplastic composite laminate, or substrate, is formed first, and then is partially or fully covered, or overlaid, by one or more over-mold elements, for example, one or more over-mold layers, during the over-molding or hybrid molding process.

The over-molding process 80 preferably comprises an injection molding process (IMP) 100 (see FIGS. 1A-1B), or another suitable over-molding process. The injection molding process 100 may comprise a single-shot injection molding process (IMP) 100a (see FIG. 1B), also referred to as an insert molding process, or a two-shot injection molding process (IMP) 100b (see FIG. 1B), also referred to as a multiple-shot injection molding process, or another suitable injection molding process.

As shown in FIG. 1B, preferably, the over-molding process 80, such as the hybrid molding process 82, is performed, or carried out, with an over-molding assembly 102, or hybrid molding assembly 104, and preferably, the over-molding assembly 102 comprises an injection molding assembly 106. As further shown in FIG. 1B, the injection molding assembly 106 preferably comprises at least a mold assembly 108, a clamping assembly 110, an injection assembly 112, and a control system 114.

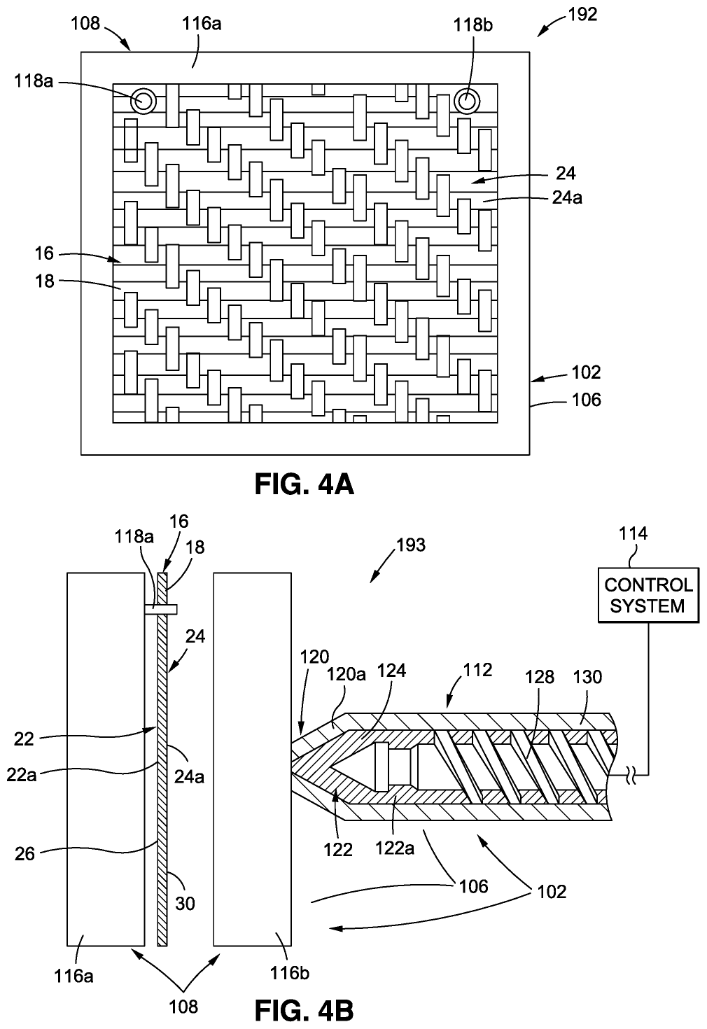

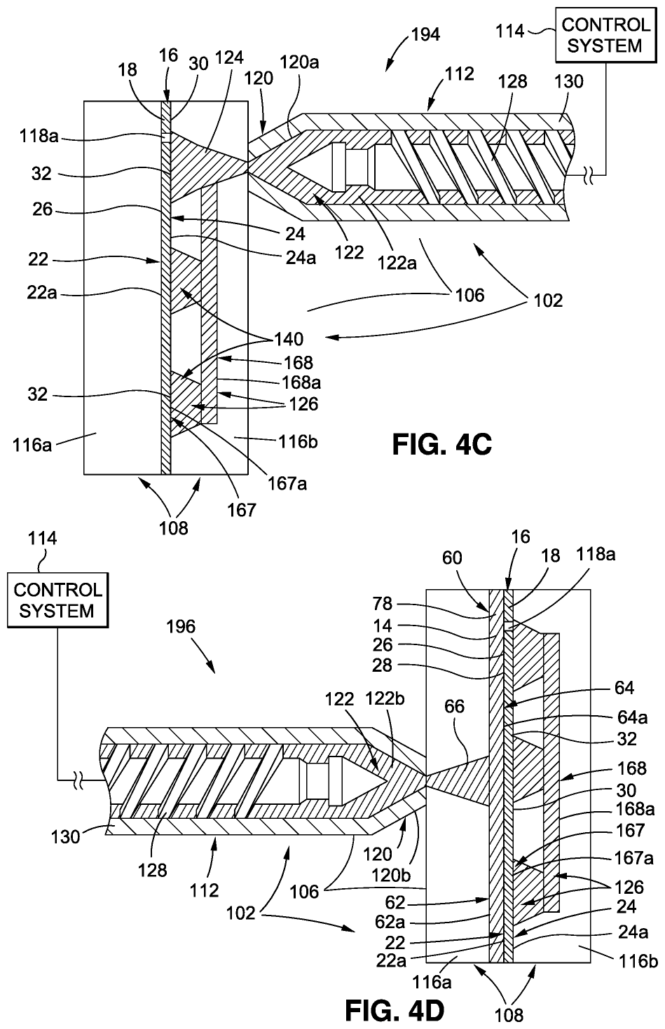

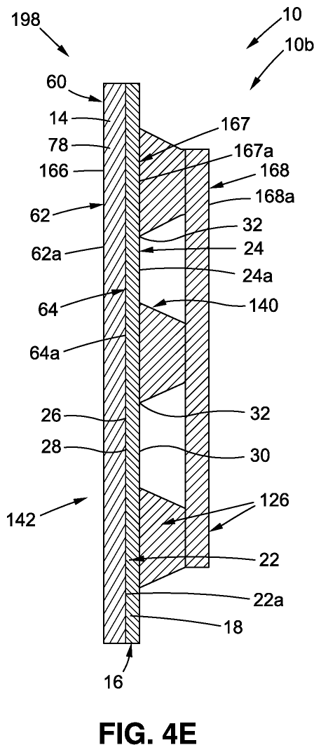

In one version, the mold assembly 108 (see FIG. 4B) may comprise a first molding tool 116a (see FIG. 4B), such as in the form of a stationary platen, or stationary mold plate, made of aluminum, steel, or another suitable metal material, and a second molding tool 116b (see FIG. 4B), such as in the form of a movable platen, or movable mold plate, made of aluminum, steel, or another suitable metal material. The choice of metal material used for the mold assembly 108 depends on the quantity and quality of the over-molded thermoplastic composite part 10 to be fabricated or produced, the longevity of the mold assembly 108 required, and the type of consolidated thermoplastic composite laminate 16 being used in the application.

The consolidated thermoplastic composite laminate 16 (see FIG. 4B) may be secured and aligned between the first molding tool 116a (see FIG. 4B) and the second molding tool 116b (see FIG. 4B) with molding tool alignment pins 118a, 118b (see FIG. 4A) of the clamping assembly 110 (see FIG. 1B). The mold assembly 108 may further comprise one or more of, an intermediate mold plate, support plates, tie bars, ejector bars or plates, or other known mold assembly components or parts for injection molding assemblies. The clamping assembly 110 may further comprise one or more of, a clamping device, a hydraulic press, a mold clamping cylinder, a clamping motor, or other known clamping assembly components or parts for injection molding assemblies.

The injection assembly 112 (see FIGS. 1B, 4B-4D) comprises one or more injection devices 120 (see FIGS. 4B-4D), such as a first injection nozzle 120a (see FIGS. 4B-4C), and/or a second injection nozzle 120b, configured to inject, and injecting, an injection molding compound (IMC) 122 (see FIGS. 1B, 4B-4D), under high pressure, over the one or more portions 28 (see FIGS. 1A, 4D) of the first side 22 (see FIGS. 1A, 4D), and/or over the one or more portions 32 (see FIGS. 1A, 4C) of the second side 24 (see FIGS. 1A, 4C) of the consolidated thermoplastic composite laminate 16 (see FIGS. 1A, 4C, 4D). As shown in FIG. 1B, the injection molding compound (IMC) 122 may comprise a reinforced injection molding compound (IMC) 122a, or an unreinforced injection molding compound (IMC) 122b. In one version, the injection molding compound 122, such as in the form of the unreinforced injection molding compound 122b, may comprise the over-mold mixture 66 (see FIG. 1A) injected over the one or more portions 28 of the first side 22 of the of the consolidated thermoplastic composite laminate 16, to form the over-mold layer 60 (see FIG. 1A). In another version, the injection molding compound 122, such as in the form of the reinforced injection molding compound 122b, may comprise a structural over-mold mixture (STRUC. O-M MIX.) 124 (see FIG. 1A) injected over the one or more portions 28 of the first side 22 of the consolidated thermoplastic composite laminate 16, prior to the application of the over-mold layer 60, or injected over the one or more portions 32 of the second side 24 of the of the consolidated thermoplastic composite laminate 16, to form a structural over-mold (O-M) layer 126 (see FIGS. 1A-1B), discussed in further detail below.

The injection assembly 112 may further comprise one or more of, a screw 128 (see FIGS. 4B-4D) coupled to the injection device 120, for example, a rotating and reciprocating screw, an injection cylinder 130 (see FIGS. 4B-4D) housing the screw 128, a drive unit such as a motor for rotating the screw, a feed hopper for feeding the injection molding compound 122, a storage container for storing the injection molding compound 122, one or more heating elements, or other known injection assembly components or parts for injection molding assemblies. The control system 114 (see FIG. 1B) may further comprise a temperature control system, for example, including a barrel temperature controller, a nozzle temperature controller, or other known controllers for injection molding assemblies.

The over-molding process 80, such as the injection molding process 100, is preferably carried out at a temperature in a temperature range of from 220° C. (Celsius) to 450° C. (428° F. (Fahrenheit) to 842° F.). The over-molding process 80, such as the injection molding process 100, is preferably carried out at an effective pressure in an effective pressure range, where the pressure is selected based on the part geometry. In addition, the thicknesses and thickness ranges for the consolidated thermoplastic composite laminate 16, the one or more over-mold layers 60, and the structural over-mold layer 126 are selected based on the part geometry.

As shown in FIGS. 1A-1B, the over-molded thermoplastic composite part 10 may further optionally comprise the structural over-mold layer 126. In one version, as shown in FIG. 2B, discussed in further detail below, the structural over-mold layer 126 is over-molded over one or more portions 32 (see also FIG. 1A) of the second side 24 (see also FIG. 1A) of the consolidated thermoplastic composite laminate 16, and is over-molded by the over-molding process 80. In one version, as shown in FIG. 2D, discussed in further detail below, the structural over-mold layer 126 is over-molded over one or more portions 28 (see also FIG. 1A) of the first side 22 (see also FIG. 1A) of the consolidated thermoplastic composite laminate 16, and is over-molded by the over-molding process 80, prior to the over-mold layer 60 with the one or more additives 70 (see FIG. 1A) being over-molded on the first side 22 of the consolidated thermoplastic composite laminate 16.

As shown in FIG. 1A, the structural over-mold layer 126 is comprised of, or made of, the structural over-mold mixture 124. The structural over-mold mixture 124 is comprised of, or made of, one or more structural over-mold polymer materials (STRUC. O-M PM) 132 mixed with a reinforcement material (REINFOR. MAT.) 134. The reinforcement material 134 (see FIG. 1A) may comprise discontinuous fibers 56b (see FIG. 1A), such as chopped carbon fibers 134a (see FIG. 1A), or other suitable reinforcement material, to add reinforcement to the one or more structural over-mold polymer materials 132. The structural over-mold layer 126 is preferably made with the compounding process 72 (see FIG. 1A), such as the melt blending process 72a (see FIG. 1A), using the compounding assembly 73 (see FIG. 1A).

The structural over-mold polymer material 132 is comprised of one or more polymer materials 40 (see FIG. 1A), such as one or more thermoplastic materials 42 (see FIG. 1A). As shown in FIG. 1A, the polymer material 40, such as the thermoplastic material 42, preferably comprises one or more of, polyaryletherketones (PAEKs) 40a, such as polyether ether ketone (PEEK) 40b and polyether ketone ketone (PEKK) 40c, polyetherimide (PEI) 40d, polyimide (PI) 40e, polyphenylene sulfide (PPS) 40f, nylon 40g, polyamide (PA) 40h, polysulfone (PSU) 40i, polyethylene terephthalate (PET) 40j, polyester 40k, polypropylene (PP) 40l, polyethylene (PE) 40m, polyvinyl chloride (PVC) 40n, polycarbonate (PC) 40o, polyphenylsulfone (PPSU) 40p, or another suitable polymer material.

In one version of fabricating the over-molded thermoplastic composite part 10 with the over-molded color 14, the one or more polymer materials 40 used to form the laminate polymer material 34 may be the same polymer material(s) 41a (see FIG. 1A) as the one or more polymer materials 40 used to form the structural over-mold polymer material 132. In another version of fabricating the over-molded thermoplastic composite part 10 with the over-molded color 14, the one or more polymer materials 40 used to form the laminate polymer material 34 may be one or more of different polymer material(s) 41b (see FIG. 1A) as the one or more polymer materials 40 used to form the structural over-mold polymer material 132.

Each of the one or more structural over-mold polymer materials 132 has a melting temperature 136 (see FIG. 1A) and a thermal degradation temperature 138 (see FIG. 1A). If the over-molded thermoplastic composite part 10 includes the structural over-mold layer 126, it is critical, or a requirement, to fabricate the over-molded thermoplastic composite part 10 so that the structural over-mold polymer material 132, for example, each of the one or more structural over-mold polymer materials 132, has a melting temperature 136 that is greater than, or equal to, the melting temperature 36 of the laminate polymer material 34, for example, each of the one or more laminate polymer materials 34, and so that the melting temperature 136 of the structural over-mold polymer material 132, for example, each of the one or more structural over-mold polymer materials 132, is less than the thermal degradation temperature 38 of the laminate polymer material 34, for example, each of the one or more laminate polymer materials 34.

The structural over-mold layer 126 is comprised of, or made of, the structural over-mold mixture 124 forming one or more structural elements 140 (see FIGS. 1A-1B) on either the second side 24 of the consolidated thermoplastic composite laminate 16, or the first side 22 of the consolidated thermoplastic composite laminate 16. As shown in FIG. 1B, the one or more structural elements 140 may comprise one or more of, stiffener elements 140a, attachment point elements 140b, clips 140c, brackets 140d, or other suitable structural elements, to improve the structural performance of the consolidated thermoplastic composite laminate 16, such as the base laminate 18, or the substrate 20.

The over-molding process 80, such as the injection molding process 100, results in the over-molded thermoplastic composite part 10 having the over-molded color 14, and having a final net shape 142 (see FIG. 1B), to obtain a final net shape part 144 (see FIG. 1B), that requires no finishing operations 146 (see FIG. 1B), or post-fabrication operations, or secondary operations, prior to using the over-molded thermoplastic composite part 10 (see FIGS. 1A-1B), such as for installation 148 (see FIG. 1B) in a vehicle 12, or such as for assembly 150 (see FIG. 1B) together with one or more structures 152 (see FIG. 1B). As shown in FIG. 1B, the finishing operations 146 may include one or more surface preparation operations 146a of the over-molded thermoplastic composite part 10, one or more painting operations 146b of the over-molded thermoplastic composite part 10, one or more trimming operations 146c of the over-molded thermoplastic composite part 10, or other suitable finishing operations of the over-molded thermoplastic composite part 10. The surface preparation operations 146a may include sanding, grit blasting, laser ablation, plasma treatment, surface treatment, or another suitable preparation operation.

As shown in FIG. 1B, in another version of the disclosure, there is provided the vehicle 12 having an exterior 154 and an interior 156, and comprising one or more over-molded thermoplastic composite parts 10, each having an over-molded color 14 and imparting color 78 to the consolidated thermoplastic composite laminate 16, and to the over-molded thermoplastic composite part 10. Each of the one or more over-molded thermoplastic composite parts 10 may be installed on one or more exterior portions 154a (see FIG. 1B) of the exterior 154 of the vehicle 12, and/or on one or more interior portions 156a (see FIG. 1B) of the interior 156 of the vehicle 12.

As discussed in detail above, as shown in FIG. 1B, each of the one or more over-molded thermoplastic composite parts 10 in the vehicle 12 comprises the consolidated thermoplastic composite laminate 16 over-molded with the over-mold layer 60, via the over-molding process 80, such as the injection molding process 100, over the first side 22 of the consolidated thermoplastic composite laminate 16. As further shown in FIG. 1B, the over-mold layer 60 comprises the over-mold polymer material 68 mixed with the one or more additives 70, comprising at least a color additive 76 to impart color 78 to the consolidated thermoplastic composite laminate 16 during the over-molding process 80, such as the injection molding process 100. As shown in FIG. 1B, the one or more additives 70 may further optionally comprise one or more ultraviolet (UV) stabilizer additives 86, as discussed above, one or more thermal conductivity additives 96, as discussed above, one or more electrical conductivity additives 98, as discussed above, or another suitable additive.

As further shown in FIG. 1B, each of the one or more of the over-molded thermoplastic composite parts 10 in the vehicle 12 may further comprise the structural over-mold layer 126 over-molded either over the second side 24 of the consolidated thermoplastic composite laminate 16, or over the first side 22 of the consolidated thermoplastic composite laminate 16, and over-molded by the over-molding process 80, such as the injection molding process 100. The structural over-mold layer 126 comprises the structural over-mold mixture 124 (see FIG. 1A) forming the one or more structural elements 140 (see FIG. 1B), such as stiffener elements 140a (see FIG. 1B), attachment point elements 140b (see FIG. 1B), clips 140c (see FIG. 1B), brackets 140d (see FIG. 1B), or other suitable structural elements, to improve the structural performance of the consolidated thermoplastic composite laminate 16, such as the base laminate 18, or the substrate 20.

The over-molding process 80, such as the injection molding process 100, results in each of the one or more over-molded thermoplastic composite parts 10 having the over-molded color 14, having the final net shape 142, and requiring no finishing operations 146, prior to each of the one or more over-molded thermoplastic composite parts being installed on one or more of, exterior portions 154a of the exterior 154 of the vehicle 12, and interior portions 156a of the interior 156 of the vehicle 12.

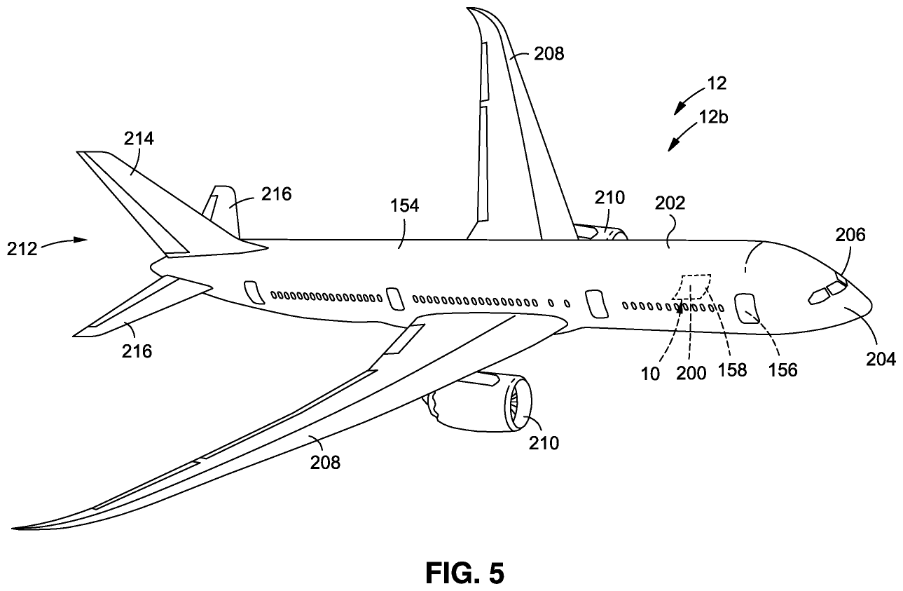

As shown in FIG. 1B, the vehicle 12 comprises an aerospace vehicle 12a, an aircraft 12b, an unmanned aerial vehicle (UAV) 12c such as a drone, a spacecraft 12d, a rotorcraft 12e, an automobile 12f, a truck 12g, a watercraft 12h, or another suitable vehicle. When the vehicle 12 (see FIGS. 1B, 5) comprises an aircraft 12b (see FIGS. 1B, 5), one or more of the one or more over-molded thermoplastic composite parts 10 may be installed in a cabin 158 (see FIGS. 1B, 5) in the interior 156 (see FIGS. 1B, 5) of the aircraft 12b, and preferably installed in visible areas 164 (see FIG. 1B), so that the over-molded color 14 of one or more of the over-molded thermoplastic composite parts 10 is visible to passengers 160 (see FIG. 1B) in the cabin 158. When the vehicle 12 (see FIG. 1B) comprises an unmanned aerial vehicle (UAV) 12c (see FIG. 1B), such as a drone, one or more of the one or more over-molded thermoplastic composite parts 10 may be installed on exterior portions 154a (see FIG. 1B) of the exterior 154 (see FIG. 1B) of the UAV 12c, and preferably installed on a visible surface 166 (see FIG. 1B) of the exterior 154, so that the color 78 of the one or more of the over-molded thermoplastic composite parts 10 is visible to users 162 (see FIG. 1B) of the UAV 12c. Preferably, the over-mold layer 60 with the over-molded color 14 and the color 78 is visible to passengers 160 in the vehicle 12, or users 162 of the vehicle 12.

Now referring to FIG. 2A, FIG. 2A is an illustration of a side view of a version of an over-molded thermoplastic composite part 10, such as in the form of an over-molded thermoplastic composite part 10a, with the over-molded color 14. As shown in FIG. 2A, in this version, the over-molded thermoplastic composite part 10, such as in the form of over-molded thermoplastic composite part 10a, comprises the consolidated thermoplastic composite laminate 16, such as the base laminate 18, having a first side 22, such as a top side 22a, and a second side 24, such as a bottom side 24a, and a thickness 33. The first side 22 has a surface 26 (see FIG. 2A), and the second side 24 has a surface 30 (see FIG. 2A).

As further shown in FIG. 2A, the over-molded thermoplastic composite part 10, such as in the form of over-molded thermoplastic composite part 10a, comprises the over-mold layer 60 over-molded over the surface 26 of the first side 22 the consolidated thermoplastic composite laminate 16. As shown in FIG. 2A, the over-mold layer 60 has a first side 62, such as a top side 62a, and a second side 64, such as a bottom side 64a, and a thickness 65. The over-mold layer 60 comprises a visible surface 166, so that the over-molded color 14 is visible. As shown in FIG. 2A, the over-molded thermoplastic composite part 10, such as in the form of over-molded thermoplastic composite part 10a, has a final net shape 142 requiring no finishing operations 146 (see FIG. 1B). The total thickness of the over-molded thermoplastic composite part 10 depends on the part geometries.

Now referring to FIG. 2B, FIG. 2B is an illustration of a side view of another version of an over-molded thermoplastic composite part 10, such as such as in the form of an over-molded thermoplastic composite part 10a, with the over-molded color 14, and further having the structural over-mold layer 126. As shown in FIG. 2B, in this version, the over-molded thermoplastic composite part 10, such as in the form of over-molded thermoplastic composite part 10b, comprises the consolidated thermoplastic composite laminate 16, such as the base laminate 18, having the first side 22, such as the top side 22a, with the surface 26, and the second side 24, such as the bottom side 24a, and with the surface 30.

As further shown in FIG. 2B, the over-molded thermoplastic composite part 10, such as in the form of over-molded thermoplastic composite part 10b, comprises the over-mold layer 60 over-molded over the surface 26 of the first side 22 the consolidated thermoplastic composite laminate 16. As shown in FIG. 2B, the over-mold layer 60 has the first side 62, such as the top side 62a, which is the visible surface 166, and the second side 64, such as the bottom side 64a. As shown in FIG. 2B, the over-molded thermoplastic composite part 10, such as in the form of over-molded thermoplastic composite part 10b, has the final net shape 142 requiring no finishing operations 146 (see FIG. 1B).

As shown in FIG. 2B, the over-molded thermoplastic composite part 10, such as in the form of over-molded thermoplastic composite part 10b, further comprises the structural over-mold layer 126 over-molded over portions 32 of the surface 30 of the second side 24 the consolidated thermoplastic composite laminate 16. As shown in FIG. 2B, the structural over-mold layer 126 has a first side 167, such as a top side 167a, and a second side 168, such as a bottom side 168a, and a thickness 127. As further shown in FIG. 2B, the structural over-mold layer 126 comprises structural elements 140, such as in the form of stiffener elements 140a.

Now referring to FIG. 2C, FIG. 2C is an illustration of a bottom perspective view of the over-molded thermoplastic composite part 10, such as in the form of over-molded thermoplastic composite part 10b, of FIG. 2B. FIG. 2C shows the structural over-mold layer 126 over-molded over portions 32 of the surface 30 of the second side 24, such as the bottom side 24a, of the consolidated thermoplastic composite laminate 16. As shown in FIG. 2C, the structural over-mold layer 126 has the first side 167, such as the top side 167a coupled to the portions 32 of the surface 30 of the second side 24, and has the second side 168, such as the bottom side 168a. As further shown in FIG. 2C, the structural over-mold layer 126 comprises the structural elements 140, such as in the form of the stiffener elements 140a. In this version, the structural over-mold layer 126 is in the form of a grid structure 169 (see FIG. 2C). FIG. 2C further shows the over-mold layer 60 over the first side 22, such as the top side 22a, of the consolidated thermoplastic composite laminate 16.

Now referring to FIG. 2D, FIG. 2D is an illustration of a side view of yet another version of an over-molded thermoplastic composite part 10, such as such as in the form of an over-molded thermoplastic composite part 10c, with the over-molded color 14, and further having the structural over-mold layer 126 in between the consolidated thermoplastic composite laminate 16 and the over-mold layer 60. As shown in FIG. 2D, in this version, the over-molded thermoplastic composite part 10, such as in the form of over-molded thermoplastic composite part 10c, comprises the consolidated thermoplastic composite laminate 16, such as the base laminate 18, having the first side 22, such as the top side 22a, and the second side 24, such as the bottom side 24a.

As shown in FIG. 2D, the over-molded thermoplastic composite part 10, such as in the form of over-molded thermoplastic composite part 10c, further comprises the structural over-mold layer 126 over-molded over portions 28 of the surface 26 of the first side 22 the consolidated thermoplastic composite laminate 16. As shown in FIG. 2D, the structural over-mold layer 126 has the first side 167, such as the top side 167a, and the second side 168, such as the bottom side 168a. The second side 168 is over-molded over and coupled to portions 28 of the surface of the first side 22 of the consolidated thermoplastic composite laminate 16. The first side 167 is coupled to the second side 64 of the over-mold layer 60. As further shown in FIG. 2D, the structural over-mold layer 126 comprises structural elements 140, such as in the form of stiffener elements 140a.

As further shown in FIG. 2D, the over-molded thermoplastic composite part 10, such as in the form of over-molded thermoplastic composite part 10c, comprises the over-mold layer 60 over-molded over the first side 167 of the structural over-mold layer 126. As shown in FIG. 2D, the over-mold layer 60 has the first side 62, such as the top side 62a, which is the visible surface 166, and the second side 64, such as the bottom side 64a. The second side 64 of the over-mold layer is coupled to the first side 167 of the structural over-mold layer 126. As shown in FIG. 2B, the over-molded thermoplastic composite part 10, such as in the form of over-molded thermoplastic composite part 10c, has the final net shape 142 requiring no finishing operations 146 (see FIG. 1B).

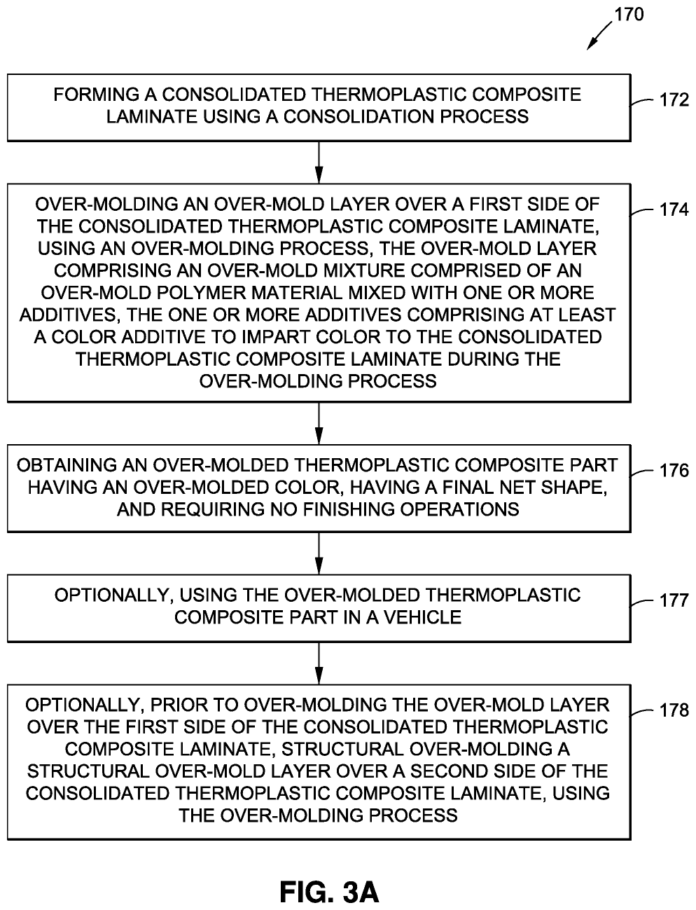

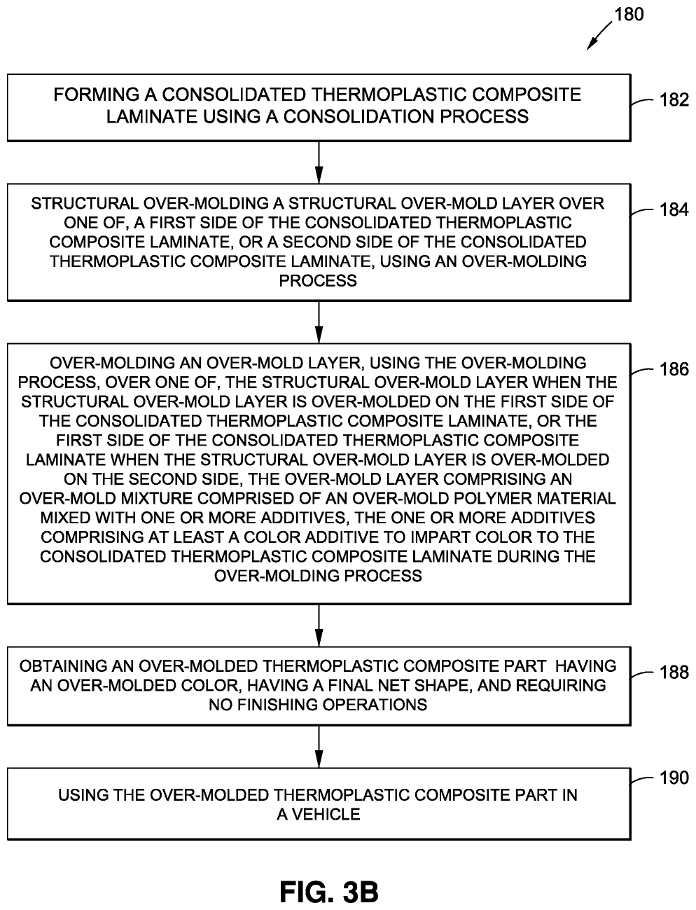

Now referring to FIG. 3A, FIG. 3A is an illustration of a flow diagram of a version of a method 170 of the disclosure. As shown in FIG. 3A, in another version of the disclosure, there is provided the method 170 of fabricating an over-molded thermoplastic composite part 10 (see FIG. 1A) having an over-molded color 14 (see FIG. 1A).

The blocks in FIG. 3A represent operations and/or portions thereof, and lines connecting the various blocks do not imply any particular order or dependency of the operations or portions thereof. FIG. 3A and the disclosure of the steps of the method 170, set forth herein, should not be interpreted as necessarily determining a sequence in which the steps are to be performed. Rather, although one illustrative order is indicated, it is to be understood that the sequence of the steps may be modified when appropriate. Accordingly, certain operations may be performed in a different order or simultaneously.

As shown in FIG. 3A, the method 170 comprises the step of forming 172 a consolidated thermoplastic composite laminate 16 (see FIG. 1A) using the consolidation process 50 (see FIG. 1A). The consolidation process 50 may comprise a continuous compression molding 50a (see FIG. 1A), a press consolidation process 50b (see FIG. 1A), or another suitable consolidation process. The consolidation process 50 is performed with the consolidation assembly 52 (see FIG. 1A). As discussed in detail above, the consolidated thermoplastic composite laminate 16 has the first side 22 (see FIG. 1A), such as the top side 22a (see FIG. 1A), with the surface 26 (see FIG. 1A), and has the second side 24 (see FIG. 1A), such as the bottom side 24a (see FIG. 1A), with the surface 30 (see FIG. 1A). The consolidated thermoplastic composite laminate 16 is comprised, or made of, a laminate polymer material 34 (see FIG. 1A).

As shown in FIG. 3A, the method 170 further comprises the step of over-molding 174 an over-mold layer 60 (see FIG. 1A) over the first side 22, such as the top side 22a, of the consolidated thermoplastic composite laminate 16, for example, over one or more portions 28 (see FIG. 1A), e.g., partially or fully, on the surface 26 (see FIG. 1A) of the first side 22 of the consolidated thermoplastic composite laminate 16, using the over-molding process 80 (see FIG. 1A), such as the injection molding process 100 (see FIG. 1A), or another suitable over-molding process. The over-molding process 80 is performed with the over-molding assembly 102 (see FIG. 1B), such as the injection molding assembly 106 (see FIG. 1B), as discussed above, or another suitable over-molding assembly. The injection molding process 100 may comprise the single-shot injection molding process 100a (see FIG. 1B), the two-shot injection molding process 100b (see FIG. 1B), or another suitable injection molding process.

As discussed in detail above, the over-mold layer 60 comprises the over-mold mixture 66 (see FIG. 1A) comprised of the over-mold polymer material 68 (see FIG. 1A) mixed with one or more additives 70 (see FIG. 1A). The over-mold polymer material 68 has a melting temperature 74 (see FIG. 1A) that is greater than, or equal to, a melting temperature 36 (see FIG. 1A) of the laminate polymer material 34, and the melting temperature 74 of the over-mold polymer material 68 is less than a thermal degradation temperature 38 (see FIG. 1A) of the laminate polymer material 34.

The laminate polymer material 34 and the over-mold polymer material 68 are each comprised of one or more polymer materials (PMs) 40 (see FIG. 1A), such as one or more thermoplastic materials 42 (see FIG. 1A). As shown in FIG. 1A, the polymer material 40, such as the thermoplastic material 42, preferably comprises one or more of polyaryletherketones (PAEKs) 40a, such as polyether ether ketone (PEEK) 40b and polyether ketone ketone (PEKK) 40c, polyetherimide (PEI) 40d, polyimide (PI) 40e, polyphenylene sulfide (PPS) 40f, nylon 40g, polyamide (PA) 40h, polysulfone (PSU) 40i, polyethylene terephthalate (PET) 40j, polyester 40k, polypropylene (PP) 40l, polyethylene (PE) 40m, polyvinyl chloride (PVC) 40n, polycarbonate (PC) 40o, polyphenylsulfone (PPSU) 40p, or another suitable polymer material. The laminate polymer material 34 and the over-mold polymer material 68 may comprise the same polymer material(s) 41a (see FIG. 1A), or may comprise different polymer material(s) 41b (see FIG. 1A).

The one or more additives 70 of the over-mold mixture 66 comprise at least the color additive 76 (see FIG. 1A) to impart color 78 (see FIG. 1A) to the consolidated thermoplastic composite laminate 16 during the over-molding process 80. As discussed above, the color additive 76 comprises one or more color dyes 76a (see FIG. 1A), one or more color paints 76b (see FIG. 1A), one or more color pigments 76c (see FIG. 1A), or another suitable color additive that gives color 78 to the over-mold layer 60, to obtain the over-mold color layer 84 (see FIG. 1A). The over-mold color layer 84 may comprise the over-mold decorative color layer 84a (see FIG. 1A), or the over-mold non-decorative color layer 84b (see FIG. 1A). The color additive 76 may be mixed together with the over-mold polymer material 68 using the compounding process 72 (see FIG. 1A), such as the melt blending process 72a (see FIG. 1A), and the compounding assembly 73 (see FIG. 1A).

The step of over-molding 174 (see FIG. 3A) the over-mold layer 60 over the first side 22 of the consolidated thermoplastic composite laminate 16, may further comprise, over-molding 174 the over-mold layer 60 comprising the over-mold mixture 66 further comprising one or more ultraviolet (UV) stabilizer additives 86 (see FIG. 1A). The one or more UV stabilizer additives 86 may comprise one or more ultraviolet (UV) absorbers 88 (see FIG. 1A), one or more ultraviolet (UV) quenchers 90 (see FIG. 1A), one or more hindered amine light stabilizer (HALS) 92 (see FIG. 1A), or other suitable UV stabilizer additives. The one or more UV stabilizer additives 86 may be mixed into the over-mold mixture 66 using the compounding process 72, such as the melt blending process 72a, and the compounding assembly 73.

The one or more UV stabilizer additives 86 may be mixed into the over-mold mixture 66 with the one or more color additives 76. Alternatively, the UV stabilizer additive 86 may be over-molded as an over-mold ultraviolet (UV) layer 94 (see FIG. 1A), and added and over-molded over, or above, the over-mold color layer 84, or added and over-molded so that it is positioned below, or under, the over-mold color layer 84, and so that the over-mold color layer 84 is over-molded over the over-mold UV layer 94. The over-mold UV layer 94 comprises an ultraviolet (UV) protective layer 94a (see FIG. 1A) to impart ultraviolet (UV) protection 95 (see FIG. 1A) to the consolidated thermoplastic composite laminate 16 and to the over-molded thermoplastic composite part 10.

The step of over-molding 174 (see FIG. 3A) the over-mold layer 60 may further comprise, over-molding 174 the over-mold layer 60 comprising the over-mold mixture 66 further comprising one or more of, the one or more ultraviolet (UV) stabilizer additives 86, one or more thermal conductivity additives 96 (see FIG. 1A) as discussed above, one or more electrical conductivity additives 98 (see FIG. 1A) as discussed above, or other suitable additive. In addition, other additives or other functional layers may be over-molded over the consolidated thermoplastic composite laminate 16, or over one or more of the over-mold layers 60 to impart additional electrical, thermal, or other properties to the consolidated thermoplastic composite laminate 16 and to the over-molded thermoplastic composite part 10.

As shown in FIG. 3A, the method 170 further comprises the step of obtaining 176 the over-molded thermoplastic composite part 10 having the over-molded color 14, having a final net shape 142 (see FIG. 1B), and requiring no finishing operations 146 (see FIG. 1B). The finishing operations 146 may comprise surface preparation operations 146a (see FIG. 1B) of the over-molded thermoplastic composite part 10, including sanding, grit blasting, laser ablation, plasma treatment, and surface treatment, and such as painting operations 146b (see FIG. 1B) of the over-molded thermoplastic composite part 10, trimming operations 146c (see FIG. 1B) of the over-molded thermoplastic composite part 10, or other suitable finishing operations. The over-molded thermoplastic composite part 10 comprises a final net shape part 144 (see FIG. 1B).

As shown in FIG. 3A, the method 170 may further optionally comprise, after the step of obtaining 176 the over-molded thermoplastic composite part 10, the step of using 177 the over-molded thermoplastic composite part 10 in a vehicle 12 (see FIG. 1B) comprising one of, an aerospace vehicle 12a (see FIG. 1B), an aircraft 12b (see FIG. 1B), an unmanned aerial vehicle (UAV) 12c (see FIG. 1B) such as a drone, a spacecraft 12d (see FIG. 1B), a rotorcraft 12e (see FIG. 1B), an automobile 12f (see FIG. 1B), a truck 12g (see FIG. 1B), a watercraft 12h (see FIG. 1B), or another suitable vehicle. The method 170 requires no finishing operations 146 prior to using the over-molded thermoplastic composite part 10, such as for installation 148 (see FIG. 1B) and use in the vehicle 12.

As shown in FIG. 3A, the method 170 may further optionally comprise, prior to the step of over-molding 174 the over-mold layer 60 over the first side 22 of the consolidated thermoplastic composite laminate 16, the step of structural over-molding 178 a structural over-mold layer 126 (see FIGS. 1A-1B) over the second side 24 of the consolidated thermoplastic composite laminate 16, using the over-molding process 80, such as the injection molding process 100, or another suitable over-molding process. As discussed above, the structural over-mold layer 126 comprises the structural over-mold mixture 124 (see FIG. 1A) comprising the structural over-mold polymer material 132 (see FIG. 1A) mixed with the reinforcement material 134 (see FIG. 1A).

The structural over-mold polymer material 132 is comprised of one or more polymer materials (PMs) 40 (see FIG. 1A), such as one or more thermoplastic materials 42 (see FIG. 1A). As shown in FIG. 1A, the polymer material 40, such as the thermoplastic material 42, preferably comprises one or more of polyaryletherketones (PAEKs) 40a, such as polyether ether ketone (PEEK) 40b and polyether ketone ketone (PEKK) 40c, polyetherimide (PEI) 40d, polyimide (PI) 40e, polyphenylene sulfide (PPS) 40f, nylon 40g, polyamide (PA) 40h, polysulfone (PSU) 40i, polyethylene terephthalate (PET) 40j, polyester 40k, polypropylene (PP) 40l, polyethylene (PE) 40m, polyvinyl chloride (PVC) 40n, polycarbonate (PC) 40o, polyphenylsulfone (PPSU) 40p, or another suitable polymer material. The reinforcement material 134 may be comprised of discontinuous fibers 56b (see FIG. 1A), for example, chopped carbon fiber 134a (see FIG. 1A), or other suitable reinforcement material.

With the structural over-molding 178 of the structural over-mold layer 126 over the second side 24 of the consolidated thermoplastic composite laminate 16, using the over-molding process 80, the structural over-mold layer 126 comprises the structural over-mold mixture 124, forming one or more structural elements 140 (see FIGS. 1A-1B) on the second side 24 of the consolidated thermoplastic composite laminate 16. As discussed above, the one or more structural elements 140 may comprise one or more stiffener elements 140a (see FIG. 1B), one or more attachment point elements 140b (see FIG. 1B), one or more clips 140c (see FIG. 1B), one or more brackets 140d (see FIG. 1B), or other suitable structural elements, to improve the structural performance of the consolidated thermoplastic composite laminate 16, or base laminate 18 (see FIG. 1A), or substrate 20 (see FIG. 1A).

Now referring to FIG. 3B, FIG. 3B is an illustration of a flow diagram of a version of a method 180 of the disclosure. As shown in FIG. 3B, in another version of the disclosure, there is provided the method 180 of fabricating an over-molded thermoplastic composite part 10 (see FIG. 1A) for use in a vehicle 12 (see FIG. 1B).

The blocks in FIG. 3B represent operations and/or portions thereof, and lines connecting the various blocks do not imply any particular order or dependency of the operations or portions thereof. FIG. 3B and the disclosure of the steps of the method 180, set forth herein, should not be interpreted as necessarily determining a sequence in which the steps are to be performed. Rather, although one illustrative order is indicated, it is to be understood that the sequence of the steps may be modified when appropriate. Accordingly, certain operations may be performed in a different order or simultaneously.

As shown in FIG. 3B, the method 180 comprises the step of forming 182 the consolidated thermoplastic composite laminate 16 (see FIG. 1A) using the consolidation process 50 (see FIG. 1A). The consolidation process 50 may comprise the continuous compression molding 50a (see FIG. 1A), the press consolidation process 50b (see FIG. 1A), or another suitable consolidation process. The consolidation process 50 is performed with the consolidation assembly 52 (see FIG. 1A). As discussed in detail above, the consolidated thermoplastic composite laminate 16 has the first side 22 (see FIG. 1A), such as the top side 22a (see FIG. 1A), with the surface 26 (see FIG. 1A), and has the second side 24 (see FIG. 1A), such as the bottom side 24a (see FIG. 1A), with the surface 30 (see FIG. 1A). The consolidated thermoplastic composite laminate 16 is comprised, or made of, the laminate polymer material 34 (see FIG. 1A).

As shown in FIG. 3B, the method 180 further comprises the step of structural over-molding 184 the structural over-mold layer 126 (see FIG. 1A) over one of, the first side 22 of the consolidated thermoplastic composite laminate 16, or the second side 24 of the consolidated thermoplastic composite laminate 16, using the over-molding process 80 (see FIG. 1A). As discussed above, the structural over-mold layer 126 comprises the structural over-mold mixture 124 (see FIG. 1A) comprising the structural over-mold polymer material 132 (see FIG. 1A) mixed with the reinforcement material 134 (see FIG. 1A). The structural over-mold polymer material 132 is comprised of one or more polymer materials (PMs) 40 (see FIG. 1A) discussed above, such as one or more thermoplastic materials 42 (see FIG. 1A). The reinforcement material 134 may be comprised of discontinuous fibers 56b (see FIG. 1A), for example, chopped carbon fiber 134a (see FIG. 1A), or other suitable reinforcement material. The structural over-mold layer 126 comprises the structural over-mold mixture 124, forming one or more structural elements 140 (see FIGS. 1A-1B) on the second side 24 of the consolidated thermoplastic composite laminate 16. As discussed above, the one or more structural elements 140 may comprise one or more stiffener elements 140a (see FIG. 1B), one or more attachment point elements 140b (see FIG. 1B), one or more clips 140c (see FIG. 1B), one or more brackets 140d (see FIG. 1B), or other suitable structural elements, to improve the structural performance of the consolidated thermoplastic composite laminate 16, or base laminate 18 (see FIG. 1A), or substrate 20 (see FIG. 1A).

As shown in FIG. 3B, the method 180 further comprises the step of over-molding 186 the over-mold layer 60 (see FIG. 1A) using the over-molding process 80 (see FIG. 1A), such as the injection molding process 100 (see FIG. 1A), or another suitable over-molding process, over one of, the structural over-mold layer 126 when the structural over-mold layer 126 is over-molded on the first side 22 of the consolidated thermoplastic composite laminate 16, or the first side 22 of the consolidated thermoplastic composite laminate 16 when the structural over-mold layer 126 is over-molded on the second side 24 of the consolidated thermoplastic composite laminate 16. In one version, as shown in FIG. 2B, the structural over-mold layer 126 is over-molded over the second side 24 of the consolidated thermoplastic composite laminate 16, and the over-mold layer 60 is over-molded over the first side 22 of the consolidated thermoplastic composite laminate 16. In another version, as shown in FIG. 2D, the structural over-mold layer is over-molded over the first side 22 of the consolidated thermoplastic composite laminate 16, and the over-mold layer 60 is over-molded over the first side 167 of the structural over-mold layer 126.

The over-molding process 80 is performed with the over-molding assembly 102 (see FIG. 1B), such as the injection molding assembly 106 (see FIG. 1B), as discussed above, or another suitable over-molding assembly. The injection molding process 100 may comprise the single-shot injection molding process 100a (see FIG. 1B), the two-shot injection molding process 100b (see FIG. 1B), or another suitable injection molding process.

As discussed in detail above, the over-mold layer 60 comprises the over-mold mixture 66 (see FIG. 1A) comprised of the over-mold polymer material 68 (see FIG. 1A) mixed with one or more additives 70 (see FIG. 1A). The over-mold polymer material 68 has a melting temperature 74 (see FIG. 1A) that is greater than, or equal to, a melting temperature 36 (see FIG. 1A) of the laminate polymer material 34, and the melting temperature 74 of the over-mold polymer material 68 is less than a thermal degradation temperature 38 (see FIG. 1A) of the laminate polymer material 34.

The laminate polymer material 34 and the over-mold polymer material 68 are each comprised of one or more polymer materials (PMs) 40 (see FIG. 1A), such as one or more thermoplastic materials 42 (see FIG. 1A). As shown in FIG. 1A, the polymer material 40, such as the thermoplastic material 42, preferably comprises one or more of polyaryletherketones (PAEKs) 40a, such as polyether ether ketone (PEEK) 40b and polyether ketone ketone (PEKK) 40c, polyetherimide (PEI) 40d, polyimide (PI) 40e, polyphenylene sulfide (PPS) 40f, nylon 40g, polyamide (PA) 40h, polysulfone (PSU) 40i, polyethylene terephthalate (PET) 40j, polyester 40k, polypropylene (PP) 40l, polyethylene (PE) 40m, polyvinyl chloride (PVC) 40n, polycarbonate (PC) 40o, polyphenylsulfone (PPSU) 40p, or another suitable polymer material. The laminate polymer material 34 and the over-mold polymer material 68 may comprise the same polymer material(s) 41a (see FIG. 1A), or may comprise different polymer material(s) 41b (see FIG. 1A).

The one or more additives 70 of the over-mold mixture 66 comprise at least the color additive 76 (see FIG. 1A) to impart color 78 (see FIG. 1A) to the consolidated thermoplastic composite laminate 16 during the over-molding process 80, such as the injection molding process 100. As discussed above, the color additive 76 comprises one or more color dyes 76a (see FIG. 1A), one or more color paints 76b (see FIG. 1A), one or more color pigments 76c (see FIG. 1A), or another suitable color additive that gives color 78 to the over-mold layer 60, to obtain the over-mold color layer 84 (see FIG. 1A). The over-mold color layer 84 may comprise the over-mold decorative color layer 84a (see FIG. 1A), or the over-mold non-decorative color layer 84b (see FIG. 1A). The color additive 76 may be mixed together with the over-mold polymer material 68 using the compounding process 72 (see FIG. 1A), such as the melt blending process 72a (see FIG. 1A), and the compounding assembly 73 (see FIG. 1A).

The step of over-molding 186 (see FIG. 3B) the over-mold layer 60 may further comprise, over-molding 186 the over-mold layer 60 comprising the over-mold mixture 66 further comprising one or more ultraviolet (UV) stabilizer additives 86 (see FIG. 1A). The one or more UV stabilizer additives 86 may comprise one or more ultraviolet (UV) absorbers 88 (see FIG. 1A), one or more ultraviolet (UV) quenchers 90 (see FIG. 1A), one or more hindered amine light stabilizer (HALS) 92 (see FIG. 1A), or other suitable UV stabilizer additives. The one or more UV stabilizer additives 86 may be mixed into the over-mold mixture 66 using the compounding process 72, such as the melt blending process 72a, and the compounding assembly 73. The one or more UV stabilizer additives 86 may be mixed into the over-mold mixture 66 with the one or more color additives 76. Alternatively, the UV stabilizer additive 86 may be over-molded as an over-mold ultraviolet (UV) layer 94 (see FIG. 1A), and added and over-molded over, or above, the over-mold color layer 84, or added and over-molded so that it is positioned below, or under, the over-mold color layer 84, and so that the over-mold color layer 84 is over-molded over the over-mold UV layer 94. The over-mold UV layer 94 comprises an ultraviolet (UV) protective layer 94a (see FIG. 1A) to impart ultraviolet (UV) protection 95 (see FIG. 1A) to the consolidated thermoplastic composite laminate 16 and to the over-molded thermoplastic composite part 10.

The step of over-molding 186 (see FIG. 3B) the over-mold layer 60 may further comprise, over-molding 186 the over-mold layer 60 comprising the over-mold mixture 66 further comprising one or more of, the one or more ultraviolet (UV) stabilizer additives 86, one or more thermal conductivity additives 96 (see FIG. 1A) as discussed above, one or more electrical conductivity additives 98 (see FIG. 1A) as discussed above, or other suitable additive. In addition, other additives or other functional layers may be over-molded over the consolidated thermoplastic composite laminate 16, or over one or more of the over-mold layers 60 to impart additional electrical, thermal, or other properties to the consolidated thermoplastic composite laminate 16 and to the over-molded thermoplastic composite part 10.

As shown in FIG. 3B, the method 180 further comprises the step of obtaining 188 the over-molded thermoplastic composite part 10 having the over-molded color 14, having the final net shape 142 (see FIG. 1B), and requiring no finishing operations 146 (see FIG. 1B). The finishing operations 146 may comprise surface preparation operations 146a (see FIG. 1B) of the over-molded thermoplastic composite part 10, including sanding, grit blasting, laser ablation, plasma treatment, and surface treatment, and such as painting operations 146b (see FIG. 1B) of the over-molded thermoplastic composite part 10, trimming operations 146c (see FIG. 1B) of the over-molded thermoplastic composite part 10, or other suitable finishing operations. The over-molded thermoplastic composite part 10 comprises a final net shape part 144 (see FIG. 1B).

As shown in FIG. 3B, the method 180 further comprises the step of using 190 the over-molded thermoplastic composite part 10 in the vehicle 12. The vehicle 12 comprises one of, an aerospace vehicle 12a (see FIG. 1B), an aircraft 12b (see FIG. 1B), an unmanned aerial vehicle (UAV) 12c (see FIG. 1B) such as a drone, a spacecraft 12d (see FIG. 1B), a rotorcraft 12e (see FIG. 1B), an automobile 12f (see FIG. 1B), a truck 12g (see FIG. 1B), a watercraft 12h (see FIG. 1B), or another suitable vehicle.

Now referring to FIGS. 4A-4E, FIGS. 4A-4E show various stages of a version of the over-molding process 80 (see FIGS. 1A-1B), such as the injection molding process 100 (see FIGS. 1A-1B) to fabricate an over-molded thermoplastic composite part 10 (see FIG. 4E), such as in the form of over-molded thermoplastic composite part 10b (see FIG. 4E).

Now referring to FIG. 4A, FIG. 4A is an illustration of a bottom view of an exemplary version of a consolidated thermoplastic composite laminate 16, such as a base laminate 18, of the disclosure, installed on a first injection molding tool 116a of a mold assembly 108. FIG. 4A shows a first stage 192 of a version of the over-molding process 80 comprising installing the consolidated thermoplastic composite laminate 16 onto the mold assembly 108. The mold assembly 108 is part of the over-molding assembly 102 (see FIG. 4A), such as the injection molding assembly 106 (see FIG. 4A). As shown in FIG. 4A, the consolidated thermoplastic composite laminate 16 is secured to the face of the first injection molding tool 116a via a first molding tool alignment pin 118a and via a second molding tool alignment pin 118b. FIG. 4A further shows the second side 24, such as the bottom side 24a, of the consolidated thermoplastic composite laminate 16.

Now referring to FIG. 4B, FIG. 4B is an illustration of a side view of the consolidated thermoplastic composite laminate 16, such as the base laminate 18, of FIG. 4A, installed between the first injection molding tool 116a and a second injection molding tool 116b of the mold assembly 108. FIG. 4B shows a second stage 193 of the version of the over-molding process 80 comprising coupling an injection device 120, such as the first injection nozzle 120a, of an injection assembly 112 to the second injection molding tool 116b of the mold assembly 108. FIG. 4B shows the first molding tool alignment pin 118a securing the consolidated thermoplastic composite laminate 16 to the first injection molding tool 116a. FIG. 4B further shows the first side 22, such as the top side 22a, with the surface 26, of the consolidated thermoplastic composite laminate 16 facing the first injection molding tool 116a, and shows the second side 24, such as the bottom side 22b, with the surface 30, of the consolidated thermoplastic composite laminate 16 facing the second injection molding tool 116b.

As shown in FIG. 4B, the injection assembly 112 comprises the injection device 120, such as the first injection nozzle 120a, and a screw 128 housed within an injection cylinder 130 of the injection device 120. The injection assembly 112 may comprise additional components or parts known in the art. As further shown in FIG. 4B, the injection assembly 112 is coupled to the control system 114, which controls the feeding and dispensing of the injection molding compound 122, such as the reinforced injection molding compound 122a, from the injection assembly 112 to the mold assembly 108. As shown in FIG. 4B, the injection molding compound 122 comprises the structural over-mold mixture 124. As further shown in FIG. 4B, the over-molding assembly 102, such as the injection molding assembly 106, comprises the mold assembly 108, the injection assembly 112, and the control system 114, and further comprises the clamping assembly 110 (see FIG. 1B). The over-molding assembly 102 may comprise additional components or parts known in the art.

Now referring to FIG. 4C, FIG. 4C is an illustration of a side view of the consolidated thermoplastic composite laminate 16, such as the base laminate 18, and the mold assembly 108, of FIG. 4B, and showing the injection device 120, such as the first injection nozzle 120a, dispensing the injection molding compound 122, such as the reinforced injection molding compound 122a, for example, the structural over-mold mixture 124, from the injection assembly 112 to the mold assembly 108 to structural over-mold the structural over-mold layer 126. FIG. 4C shows a third stage 194 of the version of the over-molding process 80 comprising structural over-molding the structural over-mold layer 126 over portions 32 of the surface 30 of the second side 24, such as the bottom side 24a, of the consolidated thermoplastic composite laminate 16.

FIG. 4C shows the consolidated thermoplastic composite laminate 16, such as the base laminate 18, installed between the first injection molding tool 116a and the second injection molding tool 116b on the mold assembly 108, and shows the injection device 120, such as a first injection nozzle 120a, coupled to the second injection molding tool 116b of the mold assembly 108. FIG. 4C shows the first molding tool alignment pin 118a securing the consolidated thermoplastic composite laminate 16 to the first injection molding tool 116a. FIG. 4C further shows the first side 22, such as the top side 22a, with the surface 26, of the consolidated thermoplastic composite laminate 16 facing the first injection molding tool 116a, and shows the second side 24, such as the bottom side 22b, with the surface 30, of the consolidated thermoplastic composite laminate 16 facing the second injection molding tool 116b.

FIG. 4C further shows the injection assembly 112 comprising the injection device 120, and the screw 128 housed within the injection cylinder 130 of the injection device 120. As further shown in FIG. 4C, the injection assembly 112 is coupled to the control system 114, which controls the feeding and dispensing of the injection molding compound 122, such as the reinforced injection molding compound 122a, from the injection assembly 112 to the mold assembly 108. As shown in FIG. 4C, the injection molding compound 122 comprises the structural over-mold mixture 124. As further shown in FIG. 4C, the over-molding assembly 102, such as the injection molding assembly 106, comprises the mold assembly 108, the injection assembly 112, and the control system 114, and further comprises the clamping assembly 110 (see FIG. 1B). The over-molding assembly 102 may comprise additional components or parts known in the art.

Now referring to FIG. 4D, FIG. 4D is an illustration of a side view of the consolidated thermoplastic composite laminate 16, such as the base laminate 18, the mold assembly 108, and structural over-mold layer 126 of FIG. 4C, and showing an injection device 120, such as a second injection nozzle 120b, coupled to the first injection molding tool 116a of the mold assembly 108 and dispensing the injection molding compound 122, such as an unreinforced injection molding compound 122b, for example, the over-mold mixture 66, from the injection assembly 112 to the mold assembly 108 to over-mold the over-mold layer 60 with the over-molded color 14 over the first side 22, such as the top side 22a, of the consolidated thermoplastic composite laminate 16. FIG. 4D shows a fourth stage 196 of the version of the over-molding process 80 comprising over-molding the over-mold layer 60 over portions 28 on the surface 26 of the first side 22, such as the top side 22a, of the consolidated thermoplastic composite laminate 16 with the injection device 102, such as the second injection nozzle 120b, of the injection assembly 112.

FIG. 4D shows the injection assembly 112 comprising the injection device 120, and the screw 128 housed within the injection cylinder 130 of the injection device 120. As further shown in FIG. 4D, the injection assembly 112 is coupled to the control system 114, which controls the feeding and dispensing of the injection molding compound 122, such as the unreinforced injection molding compound 122b, from the injection assembly 112 to the mold assembly 108. As shown in FIG. 4D, the injection molding compound 122 comprises the over-mold mixture 66. As further shown in FIG. 4D, the over-molding assembly 102, such as the injection molding assembly 106, comprises the mold assembly 108, the injection assembly 112, and the control system 114, and further comprises the clamping assembly 110 (see FIG. 1B). The over-molding assembly 102 may comprise additional components or parts known in the art.

FIG. 4D further shows the over-mold layer 60, the consolidated thermoplastic composite laminate 16, and the structural over-mold layer 126 positioned between the first injection molding tool 116a and the second injection molding tool 116b in the mold assembly 108. FIG. 4D further shows the first side 62, such as the top side 62a, of the over-mold layer 60, and shows the second side 64, such as the bottom side 64a, of the over-mold layer 60, adjacent the first side 22, such as the top side 22a, of the consolidated thermoplastic composite laminate 16. The over-mold layer 60 imparts color 78 (see FIG. 4D) to the consolidated thermoplastic composite laminate 16. FIG. 4D further shows the first side 167, such as the top side 167a, of the structural over-mold layer 126, adjacent portions 32 of the surface 30 of the second side 24, such as the bottom side 24a, of the consolidated thermoplastic composite laminate 16. FIG. 4D further shows the second side 168, such as the bottom side 168a, of the structural over-mold layer 126.

Now referring to FIG. 4E, FIG. 4E is an illustration of a side view of a version of an over-molded thermoplastic composite part 10, such as in the form of over-molded thermoplastic composite part 10b, having a final net shape 142. FIG. 4E shows a fifth stage 198 of the version of the over-molding process 80 comprising obtaining the over-molded thermoplastic composite part 10, such as in the form of over-molded thermoplastic composite part 10b.

As shown in FIG. 4E, the over-molded thermoplastic composite part 10, such as in the form of over-molded thermoplastic composite part 10b, comprises the over-mold layer 60 with the over-molded color 14 over-molded over portions 28 of the surface 26 of the first side 22, such as the top surface 22a, of the consolidated thermoplastic composite laminate 16, such as the base laminate 18. FIG. 4E further shows the first side 62, such as the top side 62a, of the over-mold layer 60, and shows the second side 64, such as the bottom side 64a, of the over-mold layer 60, adjacent the first side 22, such as the top side 22a, of the consolidated thermoplastic composite laminate 16. The over-mold layer 60 has a visible surface 166 (see FIG. 4E), and the over-mold layer 60 imparts color 78 (see FIG. 4E) to the consolidated thermoplastic composite laminate 16.

As further shown in FIG. 4E, the over-molded thermoplastic composite part 10, such as in the form of over-molded thermoplastic composite part 10b, comprises the structural over-mold layer 126 over-molded over portions 32 of the surface 30 of the second side 24, such as the bottom surface 24a, of the consolidated thermoplastic composite laminate 16, such as the base laminate 18. The structural over-mold layer 126 forms structural elements 140 (see FIG. 4E). FIG. 4E further shows the first side 167, such as the top side 167a, of the structural over-mold layer 126, adjacent portions 32 of the surface 30 of the second side 24, such as the bottom side 24a, of the consolidated thermoplastic composite laminate 16, and shows the second side 168, such as the bottom side 168a, of the structural over-mold layer 126.

Now referring to FIG. 5, FIG. 5 is an illustration of a perspective view of a vehicle 12, such as in the form of an aircraft 12b, that includes an over-molded thermoplastic composite part 10 having the over-molded color 14 (see FIG. 1A), of the disclosure. As shown in FIG. 5, the over-molded thermoplastic composite part 10 is in the form of an interior panel 200 installed in the cabin 158 in the interior 156 of the vehicle 12, such as the aircraft 12b. As further shown in FIG. 5, the vehicle 12, such as in the form of aircraft 12b, comprises the exterior 154, a fuselage 202, a nose 204, a cockpit 206, wings 208 coupled to the fuselage 202, engines 210, and a tail 212 including a vertical stabilizer 214 and horizontal stabilizers 216.

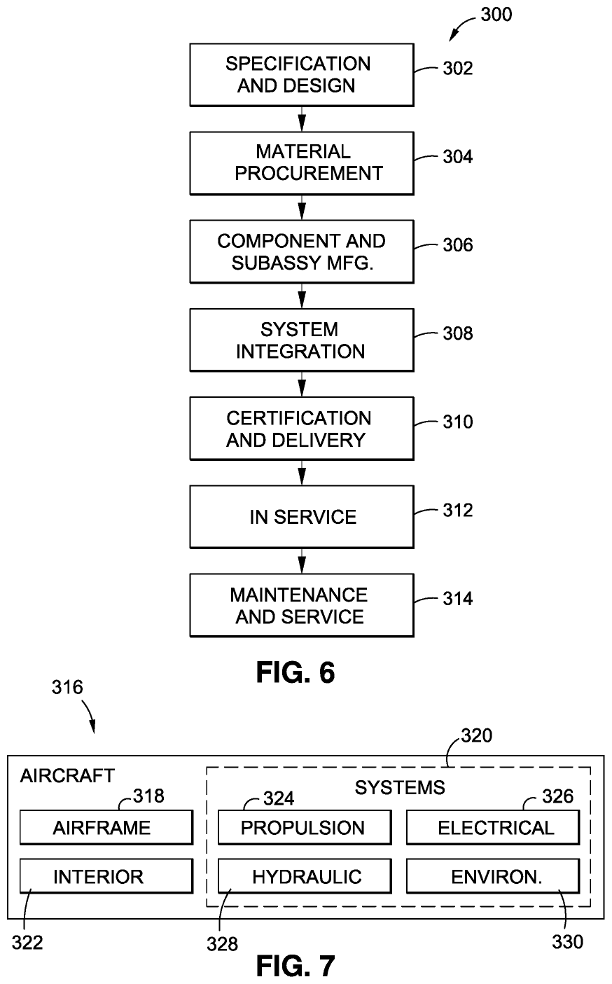

Now referring to FIGS. 6 and 7, FIG. 6 is an illustration of a flow diagram of an exemplary aircraft manufacturing and service method 300, and FIG. 7 is an illustration of an exemplary block diagram of an aircraft 316. Referring to FIGS. 6 and 7, versions of the disclosure may be described in the context of the aircraft manufacturing and service method 300 as shown in FIG. 6, and the aircraft 316 as shown in FIG. 7.

During pre-production, exemplary aircraft manufacturing and service method 300 may include specification and design 302 of the aircraft 316 and material procurement 304. During manufacturing, component and subassembly manufacturing 306 and system integration 308 of the aircraft 316 takes place. Thereafter, the aircraft 316 may go through certification and delivery 310 in order to be placed in service 312. While in service 312 by a customer, the aircraft 316 may be scheduled for routine maintenance and service 314 (which may also include modification, reconfiguration, refurbishment, and other suitable services).

Each of the processes of the aircraft manufacturing and service method 300 may be performed or carried out by a system integrator, a third party, and/or an operator (e.g., a customer). For the purposes of this description, a system integrator may include, without limitation, any number of aircraft manufacturers and major-system subcontractors. A third party may include, without limitation, any number of vendors, subcontractors, and suppliers. An operator may include an airline, leasing company, military entity, service organization, and other suitable operators.

As shown in FIG. 7, the aircraft 316 produced by the exemplary aircraft manufacturing and service method 300 may include an airframe 318 with a plurality of systems 320 and an interior 322. Examples of the plurality of systems 320 may include one or more of a propulsion system 324, an electrical system 326, a hydraulic system 328, and an environmental system 330. Any number of other systems may be included. Although an aerospace example is shown, the principles of the disclosure may be applied to other industries, such as the automotive industry.

Methods and systems embodied herein may be employed during any one or more of the stages of the aircraft manufacturing and service method 300. For example, components or subassemblies corresponding to component and subassembly manufacturing 306 may be fabricated or manufactured in a manner similar to components or subassemblies produced while the aircraft 316 is in service 312. Also, one or more apparatus embodiments, method embodiments, or a combination thereof, may be utilized during component and subassembly manufacturing 306 and system integration 308, for example, by substantially expediting assembly of or reducing the cost of the aircraft 316. Similarly, one or more of apparatus embodiments, method embodiments, or a combination thereof, may be utilized while the aircraft 316 is in service 312, for example and without limitation, to maintenance and service 314.

Disclosed embodiments of the over-molded thermoplastic composite part 10 (see FIGS. 1A, 2A, 2B, 2D), the vehicle 12 (see FIGS. 1B, 5) comprising one or more of the over-molded thermoplastic composite parts 10, and the method 170 (see FIG. 3A) and the method 180 (see FIG. 3B) of fabricating the over-molded thermoplastic composite part 10 provide for the application of over-molding, also referred to as hybrid molding, to impart color 78 (see FIG. 1A) and, optionally, ultraviolet (UV) (light) protection 95 (see FIG. 1A) to a formed thermoplastic composite part 58 (see FIG. 1A). This is accomplished by over-molding the over-mold layer 60 (see FIG. 1A), via the over-molding process 80 (see FIG. 1A), such as the injection molding process 100 (see FIG. 1A), onto the consolidated thermoplastic composite laminate 16 (see FIG. 1A), where the injection molding compound 122 (see FIG. 1B) is either a reinforced injection molding compound 122a (see FIG. 1B), or an unreinforced injection molding compound 122b (see FIG. 1B) containing color 78 (see FIG. 1A), and optionally containing one or more ultraviolet (UV) stabilizer additives 86 (see FIG. 1A) to provide ultraviolet (UV) protection 95 (see FIG. 1A). The UV protection 95 may be provided by one or more ultraviolet (UV) stabilizer additives 86 (see FIG. 1A), such as an ultraviolet (UV) absorber 88 (see FIG. 1A), for example, titanium dioxide 88a (see FIG. 1A), such as an ultraviolet (UV) quencher 90 (see FIG. 1A), or such as a hindered amine light stabilizer (HALS) 92, added to the over-mold mixture 66 (see FIG. 1A), to impart UV protection 95 to the consolidated thermoplastic composite laminate 16.

An additional benefit to the over-molding process 80, such as the injection molding process 100, is that after completion of the over-molding, the over-molded thermoplastic composite part 10, such as the formed thermoplastic composite part 58 (see FIG. 1A), that is removed from mold assembly 108 (see FIGS. 1B, 4D) is a final net shape part 144 (see FIG. 1B) that is ready for installation 148 (see FIG. 1B) on a vehicle 12 (see FIGS. 1A, 5), such as an aircraft 12b (see FIGS. 1A, 5), or ready for assembly 150 (see FIG. 1B) with one or more structures 152 (see FIG. 1B). By the addition of other additives 70 to the color additive 76 (see FIG. 1A) of the over-mold mixture 66 forming the over-mold layer 60, secondary functionality may be added to the over-mold color layer 84 (see FIG. 1A), including one or more ultraviolet (UV) stabilizer additives 86 (see FIG. 1A) to provide UV protection 95, one or more thermal conductivity additives 96 (see FIG. 1A) to provide thermal conductivity, and/or one or more electrical conductivity additives 98 (see FIG. 1A) to provide electrical conductivity. One or more polymer materials 40 (see FIG. 1A) are used in the over-molding process 80, such as the injection molding process 100. The polymer material 40 chosen preferably determines the field of use of the final over-molded thermoplastic composite part 10, such as the formed thermoplastic composite part 58. For example, if the polymer material 40 comprises polyether ether ketone (PEEK) 40b (see FIG. 1A) for the laminate polymer material 34 (see FIG. 1A) of the consolidated thermoplastic composite laminate 16 and/or the over-mold polymer material 68 (see FIG. 1A) of the over-mold layer 60 (see FIG. 1A), the formed thermoplastic composite part 58 may be suitable for aerospace applications 44 (see FIG. 1B), and if the polymer material 40 comprises polyamide (PA) 40h (see FIG. 1A) for the laminate polymer material 34 of the consolidated thermoplastic composite laminate 16 and/or the over-mold polymer material 68 of the over-mold layer 60, the formed thermoplastic composite part 58 may be suitable for automotive applications 46 (see FIG. 1B). The main requirements, as discussed above, are that the over-mold polymer material 68 has a melting temperature 74 (see FIG. 1A) that is greater than, or equal to, the melting temperature 38 (see FIG. 1A) of the laminate polymer material 34, and that the melting temperature 74 of the over-mold polymer material 68 is less than and does not exceed the thermal degradation temperature 38 of the laminate polymer material 34.

Moreover, disclosed embodiments of the over-molded thermoplastic composite part 10 (see FIGS. 1A, 2A, 2B, 2D), the vehicle 12 (see FIGS. 1B, 5) comprising one or more of the over-molded thermoplastic composite parts 10, and the method 170 (see FIG. 3A) and the method 180 (see FIG. 3B) of fabricating the over-molded thermoplastic composite part 10 eliminate multiple process steps, reduce cycle time and non-recurring costs, reduce the amount and cost of labor required, and enable an increased speed of manufacturing of over-molded thermoplastic composite parts 10. The fabrication process may be reduced from one or two shifts down to 30 seconds to 45 seconds. In addition, fabrication of the over-molded thermoplastic composite parts 10 (see FIGS. 1A, 2A, 2B, 2D) requires no finishing operations 146 (see FIG. 1B), such as surface preparation operations 146a (see FIG. 1B), including sanding, grit blasting, laser ablation, plasma treatment, and surface treatment, and such as painting operations 146b (see FIG. 1B), trimming operations 146c (see FIG. 1B), and other finishing operations, and does not require laminate machining. Fabrication of the over-molded thermoplastic composite parts 10 (see FIGS. 1A, 2A, 2B, 2D) with the over-molded color 14 eliminates the need to trim the over-molded thermoplastic composite parts 10, eliminates multiple surface preparation steps that may be required when painting a composite material, and creates a final net shape part 144 (see FIG. 1B) out of the over-molding assembly 102 (see FIG. 1B), such as the injection molding assembly 106 (see FIG. 1B). The fabrication of the over-molded thermoplastic composite parts 10 removes multiple steps from the process to fabricate a complete and ready to install the formed thermoplastic composite part 58, reducing the time, labor, and overall manufacturing costs associated with the part manufacture, and reducing the overall installation costs as well.

Further, all the processes associated with painting, including masking, priming, painting, demasking, and cleanup are eliminated with fabrication of the over-molded thermoplastic composite parts 10, and because these processes associated with painting are eliminated, the need for paint facilities, such as a paint booth, and the need for painters are also eliminated. In addition, paint curing time is eliminated, and the overall processing and cycle time are reduced. Thus, the simplicity of the over-molded thermoplastic composite part 10, and the method 170 (see FIG. 3A), and the method 180 (see FIG. 3B), allow for cost reduction and reduced cycle time by eliminating the painting operations.

The fabrication of the over-molded thermoplastic composite part 10 with the over-molded color 14, using the over-molding process 80 (see FIG. 1B), such as the injection molding process 100 (see FIG. 1B), results in a formed thermoplastic composite part 58 with color 78 (see FIG. 1B) on a visible surface 166 (see FIG. 1B) that is visible to passengers 160 (see FIG. 1B) and users 162 (see FIG. 1B). The over-molded thermoplastic composite parts 10 are used in and on vehicles 12 (see FIG. 1B), such as aircraft 12b (see FIG. 1B), automobiles 12f (see FIG. 1B), and other vehicles. With usage of the over-molded thermoplastic composite parts 10 on a vehicle 12, such as an unmanned aerial vehicle (UAV) 12c (see FIG. 1B) or drone, the over-molded thermoplastic composite parts 10 may be used as structural or non-structural skins on the outside of the exterior 154 (see FIG. 1B) of the unmanned aerial vehicle (UAV) 12c (see FIG. 1B) or drone. With usage of the over-molded thermoplastic composite parts 10 on a vehicle 12, such as an aircraft 12b (see FIGS. 1B, 5), the over-molded thermoplastic composite parts 10 may be used in areas that are interior 156 (see FIGS. 1B, 5) within the cabin 158 (see FIGS. 1B, 5) and are visible to the passengers 160 (see FIG. 1B). This application would apply to both smaller and larger aircraft. With usage of the over-molded thermoplastic composite parts 10 on a vehicle 12, such as an automobile 12f (see FIG. 1B), the over-molded thermoplastic composite parts 10 may be used in areas that are on the interior 156 (see FIG. 1B) or on the exterior 154 (see FIG. 1B) of the automobile 12f and visible to the passengers 160 or the users 162.

Many modifications and other versions of the disclosure will come to mind to one skilled in the art to which this disclosure pertains having the benefit of the teachings presented in the foregoing descriptions and the associated drawings. The versions described herein are meant to be illustrative and are not intended to be limiting or exhaustive. Although specific terms are employed herein, they are used in a generic and descriptive sense only and not for purposes of limitation.

What is claimed is:

1. An over-molded thermoplastic composite part having an over-molded color, the over-molded thermoplastic composite part comprising:
a consolidated thermoplastic composite laminate formed by a consolidation process, the consolidated thermoplastic composite laminate having a first side and a second side and comprised of a laminate polymer material; and
an over-mold layer over-molded, via an over-molding process, over the first side of the consolidated thermoplastic composite laminate, the over-mold layer comprising an over-mold mixture comprised of an over-mold polymer material mixed with one or more additives, the one or more additives comprising at least a color additive to impart a color to the consolidated thermoplastic composite laminate during the over-molding process, and the over-mold polymer material having a melting temperature that is greater than, or equal to, a melting temperature of the laminate polymer material, and the melting temperature of the over-mold polymer material being less than a thermal degradation temperature of the laminate polymer material,
wherein the over-molding process results in the over-molded thermoplastic composite part having the over-molded color, having a final net shape, and requiring no finishing operations.

2. The over-molded thermoplastic composite part of claim 1, further comprising a structural over-mold layer over-molded over the second side of the consolidated thermoplastic composite laminate, and over-molded by the over-molding process, the structural over-mold layer comprising a structural over-mold mixture forming one or more structural elements on the second side.

3. The over-molded thermoplastic composite part of claim 1, wherein the over-mold mixture further comprises one or more ultraviolet (UV) stabilizer additives comprising one or more of, one or more ultraviolet (UV) absorbers, one or more ultraviolet (UV) quenchers, or one or more hindered amine light stabilizers (HALS).

4. The over-molded thermoplastic composite part of claim 3, wherein the one or more ultraviolet (UV) stabilizer additives comprises one or more ultraviolet (UV) absorbers comprising one or more of, titanium dioxide (TiO₂), carbon black, or oxanilides.

5. The over-molded thermoplastic composite part of claim 1, wherein the over-mold mixture further comprises a thermal conductivity additive comprising boron nitride.

6. The over-molded thermoplastic composite part of claim 1, wherein the laminate polymer material and the over-mold polymer material are a same polymer material comprising one of, polyaryletherketones (PAEKs), polyether ether ketone (PEEK), polyether ketone ketone (PEKK), polyetherimide (PEI), polyimide (PI), polyphenylene sulfide (PPS), nylon, polyamide (PA), polysulfone (PSU), polyethylene terephthalate (PET), polyester, polypropylene (PP), polyethylene (PE), polyvinyl chloride (PVC), polycarbonate (PC), and polyphenylsulfone (PPSU).

7. The over-molded thermoplastic composite part of claim 1, wherein the over-molding process comprises an injection molding process.

8. The over-molded thermoplastic composite part of claim 1, wherein the color additive comprises one of, one or more color dyes, one or more color paints, or one or more color pigments.

9. The over-molded thermoplastic composite part of claim 1, wherein the over-mold layer comprises one of, an over-mold decorative color layer, or an over-mold non-decorative color layer.

10. A vehicle comprising:
an exterior;
an interior; and
one or more over-molded thermoplastic composite parts, each of the one or more over-molded thermoplastic composite parts having an over-molded color, and each installed on one or more of, exterior portions of the exterior of the vehicle, and interior portions of the interior of the vehicle, and each of the one or more over-molded thermoplastic composite parts comprises:
a consolidated thermoplastic composite laminate formed by a consolidation process, the consolidated thermoplastic composite laminate having a first side and a second side and comprised of a laminate polymer material; and
an over-mold layer over-molded, via an injection molding process, over the first side of the consolidated thermoplastic composite laminate, the over-mold layer comprising an over-mold mixture comprised of an over-mold polymer material mixed with one or more additives, the one or more additives comprising at least a color additive to impart a color to the consolidated thermoplastic composite laminate during the injection molding process, and the over-mold polymer material having a melting temperature that is greater than, or equal to, a melting temperature of the laminate polymer material, and the melting temperature of the over-mold polymer material being less than a thermal degradation temperature of the laminate polymer material,
wherein the injection molding process results in each of the one or more over-molded thermoplastic composite parts having the over-molded color, having a final net shape, and requiring no finishing operations.

11. The vehicle of claim 10, wherein the vehicle comprises one of, an aerospace vehicle, an aircraft, an unmanned aerial vehicle (UAV), a spacecraft, a rotorcraft, an automobile, a truck, and a watercraft.

12. The vehicle of claim 10, wherein the vehicle comprises an aircraft having a cabin in the interior, and one or more of each of the one or more over-molded thermoplastic composite parts are installed in the cabin on one or more of the interior portions of the interior, and the over-molded color of each of the one or more over-molded thermoplastic composite parts is visible to passengers in the cabin.

13. The vehicle of claim 10, wherein one or more of the over-molded thermoplastic composite parts further comprise a structural over-mold layer over-molded over the second side of the consolidated thermoplastic composite laminate, and over-molded by the injection molding process, the structural over-mold layer comprising a structural over-mold mixture forming one or more structural elements on the second side.

14. The vehicle of claim 10, wherein the over-mold mixture further comprises one or more ultraviolet (UV) stabilizer additives comprising one or more of, one or more ultraviolet (UV) absorbers, one or more ultraviolet (UV) quenchers, or one or more hindered amine light stabilizers (HALS).

15. A method of fabricating an over-molded thermoplastic composite part having an over-molded color, the method comprising the steps of:
forming a consolidated thermoplastic composite laminate using a consolidation process, the consolidated thermoplastic composite laminate having a first side and a second side and comprised of a laminate polymer material;
over-molding an over-mold layer over the first side of the consolidated thermoplastic composite laminate, using an over-molding process, the over-mold layer comprising an over-mold mixture comprised of an over-mold polymer material mixed with one or more additives, the one or more additives comprising at least a color additive to impart color to the consolidated thermoplastic composite laminate during the over-molding process, and the over-mold polymer material having a melting temperature that is greater than, or equal to, a melting temperature of the laminate polymer material, and the melting temperature of the over-mold polymer material being less than a thermal degradation temperature of the laminate polymer material; and
obtaining the over-molded thermoplastic composite part having the over-molded color, having a final net shape, and requiring no finishing operations.

16. The method of claim 15, further comprising, after obtaining the over-molded thermoplastic composite part, using the over-molded thermoplastic composite part in a vehicle comprising one of, an aerospace vehicle, an aircraft, an unmanned aerial vehicle (UAV), a spacecraft, a rotorcraft, an automobile, a truck, and a watercraft.

17. The method of claim 15, further comprising prior to over-molding the over-mold layer over the first side of the consolidated thermoplastic composite laminate, structural over-molding a structural over-mold layer over the second side of the consolidated thermoplastic composite laminate, using the over-molding process, the structural over-mold layer comprising a structural over-mold mixture, to form one or more structural elements on the second side of the consolidated thermoplastic composite laminate.

18. The method of claim 15, wherein over-molding the over-mold layer over the first side of the consolidated thermoplastic composite laminate, further comprises, over-molding the over-mold layer comprising the over-mold mixture further comprising one or more ultraviolet (UV) stabilizer additives comprising one or more of, one or more ultraviolet (UV) absorbers, one or more ultraviolet (UV) quenchers, or one or more hindered amine light stabilizers (HALS).

19. The method of claim 15, wherein over-molding the over-mold layer, further comprises, over-molding the over-mold layer comprising the over-mold mixture further comprising one or more of, one or more ultraviolet (UV) stabilizer additives, one or more thermal conductivity additives, and one or more electrical conductivity additives.

20. The method of claim 15, wherein over-molding the over-mold layer, further comprises, over-molding the over-mold layer using the over-molding process comprising an injection molding process.
